(19) United States
(12) Patent Application Publication
(10) Pub. No.: US 2024/0403330 A1
(43) Pub. Date: Dec. 5, 2024

(54) INTERACTIVE SYSTEMS AND METHODS USING CLUSTERED REAL-TIME EVENT DATA

(71) Applicant: Wincast Corp., Brooklyn, NY (US)

(72) Inventors: Noah Diskin Kline, Brooklyn, NY (US); Imri Sofer, Auburn, AL (US); Keith Hudnall, San Diego, CA (US); John Kacandes Gittens, Los Angeles, CA (US)

(21) Appl. No.: 18/732,575

(22) Filed: Jun. 3, 2024

Related U.S. Application Data
(60) Provisional application No. 63/505,557, filed on Jun. 1, 2023.

(51) Int. Cl. G06F 16/28

(52) U.S. Cl. CPC G06F 16/285

(57) ABSTRACT

A system may receive real-time event data for a real-time event. A system may determine statistic categories from the real-time event data. A system may calculate weighted statistic categories using weight functions. A system may cluster the weighted statistic categories into clustered real-time statistics. A system may receive skill allocation point selections. A system may calculate a real-time score using the clustered real-time statistics and the skill allocation point selections.

### BACKGROUND

This application relates to providing an interactive system for interacting with real-time event data.

Currently, people can perform various types of conventional sports betting. These sport betting options allow for high level betting, such as winners of games, etc. and micro betting on various statistics during the game. For example, users can place bets on how many times something happens during a sporting event and the event can collect payouts based on whether they won their micro bets. These micro bets rely on a line from a stat table and the bet exceeding or being below that stat table line.

These conventional sports betting types suffer from not being able to provide unique interactions between the live data and the users. Instead, the conventional sports betting is very much dependent on gathering the data after the event and paying out users for the appropriate bets.

### SUMMARY

In some aspects, the techniques described herein relate to a computer-implemented method including: receiving, by one or more processors, real-time event data for a real-time event; determining, by the one or more processors, statistic categories from the real-time event data; calculating, by the one or more processors, weighted statistic categories using weight functions; clustering, by the one or more processors, the weighted statistic categories into clustered real-time statistics; receiving, from a client device, skill allocation point selections; and calculating, using the one or more processors, a real-time score using the clustered real-time statistics and the skill allocation point selections.

In some aspects, the techniques described herein relate to a computer-implemented method, wherein the statistic category includes a first measurable statistic and a second measurable statistic.

In some aspects, the techniques described herein relate to a computer-implemented method, wherein the first measurable statistic and the second measurable statistic are combined to form a first statistic category from the statistic categories.

In some aspects, the techniques described herein relate to a computer-implemented method, further including: updating, by the one or more processors, one or more of the weighted statistic categories in response to detecting a change in a balance of the weighted statistic categories.

In some aspects, the techniques described herein relate to a computer-implemented method, wherein the skill allocation point selections are associated with the determined statistical categories and the skill allocation point selections include a first selection from a first category of the determined statistical categories and a second selection from a second category of the determined statistical categories.

In some aspects, the techniques described herein relate to a computer-implemented method, wherein calculating the real-time score using the clustered real-time statistics and the skill allocation point selections, further includes calculating the real-time score using the clustered real-time statistics, the first selection from the first category, and the second selection from the second category.

In some aspects, the techniques described herein relate to a computer-implemented method, further including: receiving, from the client device, an updated skill allocation point selection that changes the selection of the second selection from the second category to a third selection from a third category of the determined statistical categories.

In some aspects, the techniques described herein relate to a computer-implemented method, wherein calculating the real-time score using the clustered real-time statistics and the skill allocation point selections, further includes calculating the real-time score using the clustered real-time statistics, the first selection from the first category, and the third selection from the third category.

In some aspects, the techniques described herein relate to a computer-implemented method, wherein when the skill allocation point selections are received, a timestamp of when the client device received the skill allocation point selections is also received and wherein, the timestamp is used to calculate the real-time score using the clustered real-time statistics and the skill allocation point selections in substantially real-time.

In some aspects, the techniques described herein relate to a system including: one or more processors; and one or more memory storing instructions that, when executed by the one or more processors, cause the system to perform operations including: receiving real-time event data for a real-time event; determining statistic categories from the real-time event data; calculating weighted statistic categories using weight functions; clustering the weighted statistic categories into clustered real-time statistics; receiving skill allocation point selections; and calculating a real-time score using the clustered real-time statistics and the skill allocation point selections.

In some aspects, the techniques described herein relate to a system, wherein the statistic category includes a first measurable statistic and a second measurable statistic.

In some aspects, the techniques described herein relate to a system, wherein the first measurable statistic and the second measurable statistic are combined to form a first statistic category from the statistic categories.

In some aspects, the techniques described herein relate to a system, wherein the one or more memory further stores instructions that, when executed by the one or more processors, cause the system to perform operations including: updating one or more of the weighted statistic categories in response to detecting a change in a balance of the weighted statistic categories.

In some aspects, the techniques described herein relate to a system, wherein the skill allocation point selections are associated with the determined statistical categories and the skill allocation point selections include a first selection from a first category of the determined statistical categories and a second selection from a second category of the determined statistical categories.

In some aspects, the techniques described herein relate to a system, wherein calculating the real-time score using the clustered real-time statistics and the skill allocation point selections, further includes calculating the real-time score using the clustered real-time statistics, the first selection from the first category, and the second selection from the second category.

In some aspects, the techniques described herein relate to a system, wherein the one or more memory further stores instructions that, when executed by the one or more processors, cause the system to perform operations including: receiving an updated skill allocation point selection that changes the selection of the second selection from the second category to a third selection from a third category of the determined statistical categories.

In some aspects, the techniques described herein relate to a system, wherein calculating the real-time score using the clustered real-time statistics and the skill allocation point selections, further includes calculating the real-time score using the clustered real-time statistics, the first selection from the first category, and the third selection from the third category.

In some aspects, the techniques described herein relate to a system, wherein when the skill allocation point selections are received, a timestamp of when a client device received the skill allocation point selections is also received and wherein, the timestamp is used to calculate the real-time score using the clustered real-time statistics and the skill allocation point selections in substantially real-time.

In some aspects, the techniques described herein relate to a method including: receiving, by one or more processors, event data for a video feed of a live sporting event in substantially real-time, the event data including a first measurable statistic and a second measurable statistic captured during the live sporting event; determining, by the one or more processors, a first statistical category that is associated with the first measurable statistics and a second statistical category that is associated with the second measurable statistic; calculating, by the one or more processors, a first weight for the first statistical category and a second weight for the second statistical category using weight functions; receiving, from a client device, skill allocation point selections that include a first allocation to the first statistical category and a second allocation to the second statistical category; and calculating, using the one or more processors, a real-time score using the first weight, the first allocation to the first statistical category, and the first measurable statistic, and the second weight, the second allocation to the second statistical category, and the second weight.

In some aspects, the techniques described herein relate to a method, wherein the first allocation is a multiplier quantity.

However, this list of features and advantages is not all-inclusive and many additional features and advantages are within the scope of the present disclosure. Moreover, it should be noted that the language used in the present disclosure has been principally selected for readability and instructional purposes, and not to limit the scope of the subject matter disclosed herein.

### BRIEF DESCRIPTION OF THE DRAWINGS

FIG. 1 is a block diagram illustrating an example system for interacting with real-time event data.

FIG. 2 is a block diagram illustrating an example client device for interacting with real-time event data.

FIG. 3 is a flow diagram of an example method of clustering real-time event data.

FIG. 4 illustrate various example graphical user interfaces for providing the displays and interactions described herein.

FIG. 5 illustrates various example graphical user interfaces for providing the displays and interactions described herein

FIG. 6 illustrates various example graphical user interfaces for providing the displays and interactions described herein

FIG. 7 illustrates various example graphical user interfaces for providing the displays and interactions described herein

FIGS. 8A-8D illustrate example graphical user interfaces for showing additional selections by a user.

FIG. 9 illustrates various example graphical user interfaces for providing the displays and interactions described herein.

FIG. 10 illustrates various example graphical user interfaces for providing the displays and interactions described herein.

FIGS. 11A-11B illustrate various example graphical user interfaces for providing the displays and interactions described herein.

FIG. 12 illustrates various example graphical user interfaces for user-selectable power-ups.

FIG. 13 illustrates various example graphical user interfaces for providing the displays and interactions described herein

FIG. 14 shows an example GUI of a user ranking against other users in a group.

FIG. 15 illustrates various example GUIs for selecting various clustered real-time event data.

FIGS. 16A-16C depict a example GUIs 1600 of a user selection of different clustered real-time event data.

FIG. 17 depicts an example end game GUI.

FIGS. 18A-18B depicts example GUIs of score changes based on selecting clustered real-time event data.

FIGS. 19A-19E depict example GUIs of a tutorial screen for selecting clustered real-time event data.

FIG. 20 depicts an example GUI of a pod of users and rankings within the pod of users.

FIG. 21A-21B depict example GUIs depicting upcoming matches that can be used for selecting clustered real-time event data.

FIG. 22 depicts an example GUI depicting a user profile and trophy room associated with the user profile.

FIG. 23A-23B depict example GUIs depicting selectable captains that can be used during a selection of clustered real-time event data in an application.

FIG. 24 depicts an example GUI depicting an example match in an application that can be used to select clustered real-time event data.

FIG. 25 depicts an example GUI of an additional tutorial screen for selecting clustered real-time event data.

FIG. 26 depicts an example GUI of an application for selecting clustered real-time event data.

FIG. 27 depicts an example GUI of an application for adjusting a score based on selecting clustered real-time event data.

FIG. 28 depicts an example GUI of a group of users and rankings within the group of users.

FIG. 29 depicts example GUIs showing a selection of clustered real-time event data.

FIG. 30 depicts example GUIs showing a selection of clustered real-time event data.

FIG. 31 depicts example GUIs showing a selection of clustered real-time event data.

FIG. 32A-32D depicts example GUIs showing a selection of clustered real-time event data on a radial slider.

FIG. 33A-33D depict example GUIs showing a selection of clustered real-time event data on a radial slider.

FIG. 34 depicts example GUIs showing a selection of clustered real-time event data.

FIG. 35 depicts example GUIs showing selections of stategories for an application.

FIG. 36 depicts example GUIs showing example selections of stategories for an application.

FIG. 37 depicts an example GUI showing an upgrade a stategory trait.

FIG. 38 depicts example GUIs showing a selection of clustered real-time event data.

FIG. 39 depicts example GUIs showing a selection of clustered real-time event data.

FIG. 40 depicts example GUIs showing a selection of clustered real-time event data.

### DESCRIPTION

The present disclosure relates to systems and methods for users to interact with real-time event data in new and unique ways, such as allowing users to place various bets on outcomes that are generated by the activity application using clustered real-time event data. This clustered real-time event data provides new ways for the users to compare statistics using various weighted functions and may also provide users with interfaces to change how selections are allocated by the user in substantially real-time.

In some implementations, the technology described herein may use an activity application to generate weighted functions that allows the clustering of different types of real-time event statistics that would not be correlated without the weighted function. For example, in a basketball game, the activity application can use weighted functions to allow blocks to be compared to points during the game, or other types of statistical category combinations, etc. A user can interact with a selection application to input various selections about the comparisons between blocks and points using the weighted functions. In some implementations, the selection application can allow for substantially real-time changes in the various selections by the user as the event progresses. The activity application uses the selections from the selection application to generate a real-time score based on how the user's various selections result in actual statistical categories occurring during the event.

In some implementations, the technology described herein may allow a user to add in various power-up selections that can alter how the activity application generates a real-time score for the user based on their selections. In some implementations, these power-up selections may be collectible types of items that a user can deploy in the selection application, such as power-ups linked to a collectible non-fungible token (“NFT”) or other types of tokenized or web3 assets. In further implementations, other types of power-ups or other selection altering mechanisms may be input by a user through the selection application to alter how the activity application generates a real-time score for the user.

With reference to the figures, reference numbers may be used to refer to example components found in any of the figures, regardless of whether those reference numbers are shown in the figure being described. Further, where a reference number includes a letter referring to one of multiple similar components (e.g., component 000a, 000b, and 000n), the reference number may be used without the letter to refer to one or all of the similar components.

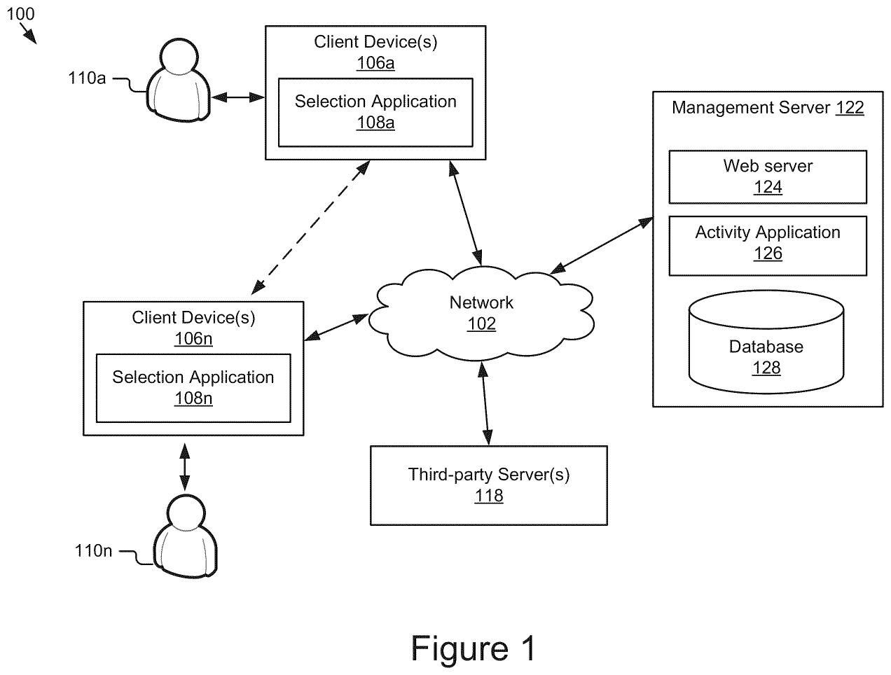

FIG. 1 is a block diagram of an example system 100 for interacting with systems and methods using clustered real-time event data. The illustrated system 100 may include one or more client devices 106a-106n, a third-party server 118, and/or a management server 122. In some implementations, the client devices 106a-106n may run instances of the selection application 108a . . . 108n and which may be electronically communicatively coupled via a network 102 for interaction with one another, although other system configurations are possible including other devices, systems, and networks. In some implementations, the management server 124 may run instances of the activity application 126 which may be electronically coupled via the network 102 to the client devices 106 and/or the third-party servers 118. For example, the system 100 could include any number of client devices 106, third party servers 118, management server(s) 122, and other systems and devices.

The network 102 may include any number of networks and/or network types. For example, the network 102 may include, but is not limited to, one or more local area networks (LANs), wide area networks (WANs) (e.g., the Internet), virtual private networks (VPNs), wireless wide area network (WWANs), WiMAX® networks, personal area networks (PANs) (e.g., Bluetooth® communication networks), various combinations thereof, etc. These private and/or public networks may have any number of configurations and/or topologies, and data may be transmitted via the networks using a variety of different communication protocols including, for example, various Internet layer, transport layer, or application layer protocols. For example, data may be transmitted via the networks using TCP/IP, UDP, TCP, HTTP, HTTPS, DASH, RTSP, RTP, RTCP, VOIP, FTP, WS, WAP, SMS, MMS, XMS, IMAP, SMTP, POP, WebDAV, or other known protocols.

The client device(s) 106 (e.g., multiple client devices 106 may be used by a single participant, multiple participants, stakeholders, or by other users) includes one or more computing devices having data processing and communication capabilities. The client device 106 may couple to and communicate with other client devices 106 and the other entities of the system 100 via the network 102 using a wireless and/or wired connection, such as the management server 122. Examples of client devices 106 may include, but are not limited to, mobile phones, wearables, smart watches, tablets, laptops, desktops, netbooks, server appliances, servers, virtual machines, TVs, etc. The system 100 may include any number of client devices 106, including client devices 106 of the same or different type.

In some implementations, one or multiple client devices 106 may be used with a selection application 108. A user 110 may stream media from a management server 122 using a first client device 106 on which an instance or component of the selection application 108 provides one or more graphical user interface (“GUI”) elements indicating a system for a user to allocate various selections, such as a skill point allocation, to different weighted clustered event data. The selection application 108 receives inputs from the user 110, for example, a skill point allocation and the selection application 108 may receive various data related to the users real-time score based on the various skill point allocations.

In some implementations, multiple client devices 106 may be used. For instance, a third-party server 118 may stream a basketball game to a television of a user 110 and the user may interact with the selection application 108 on a separate client device 106. Based on a live timing of the media stream and/or a synchronization with the media on the television with the selection application 108 on (e.g., executed on or accessed via) the smartphone, the user 110 may allocate various skill points and/or use various power-ups, etc. during the live basketball game event in their interface on the client device 106 to select and/or change various clustered real-time event data selections. For instance, the television may display the media stream while the smartphone (e.g., client device 106) provides interaction elements via which the user 110 may use to allocate skill points or other types of selections, etc. In some implementations, the client device 106 may separately display both the live media stream and/or the skill point allocations in the selection application 108.

The management server 122 and its components may aggregate information about and/or provide data associated with the systems and processes described herein to a multiplicity of users on a multiplicity of client devices 106. The management server 122 may also receive various media streams and/or data related to media streams to the activity applications 126. The activity applications 126 may use software and/or logic to generate various clustered live-event data that is comparable using weighted functions. In some instances, the activity applications 126 may generate the various weighted and clustered live-event data using artificial intelligence (“AI”) algorithms and/or machine learning to cluster the various statistics, such as into “stategories” and then weight the clustered statistics or stategories to be comparable to each other for selection by a user 110. The activity applications 126 may then compare one or more user selections from the selection applications 108a-108n to generate real-time scores for the users 110 based on their user selections and the clustered real-time event data. In some implementations, this allows a user 110 to play an activity or game with other users 110n while also viewing an event and basing the activity or game they are playing off of data gathered during the real-time event. Additionally, the user 110 can make changes in substantially real-time to adjust the user selections of stategories to allow for more interaction with the game or application while the real-time event is viewed.

One or more third-party servers 118 may be communicatively coupled with a client device 106, management server 122, and/or network 102. For example, a third-party server 118 may stream media, such as a video feed of a basketball game or other sporting event to a client device 106 or television either directly or via the management server 122. For example, the third-party server 118 may be a third-party device that streams live or substantially live event video to the management server 122, which may use weighted functions to generate various real-time event data and cluster weighted real-time event data as described elsewhere herein.

In some implementations, the activity application 126 may send information to another computing device, for example, to a client device 106 or third-party server 118. For example, the activity application 126 may determine certain information and communicate with various devices based on those details. For instance, the activity application 126 may perform the various operations described herein.

The management server 122 may include a web server 124, an activity application 126, and/or a database 128. In some configurations, the activity application 126 may be distributed over the network 102 on disparate devices in disparate locations or may reside in the same location. The client device 106a and/or the management server 122 may each include an instance of the activity application 126 and/or portions/functionalities thereof. The client devices 106 may also store and/or operate other software such as a selection application 108, an operating system, other applications, etc., that are configured to interact with the management server 122 via the network 102.

The management server 122 and/or the third-party server 118 have data processing, storing, and communication capabilities, as discussed elsewhere herein. For example, the servers 118 and/or 122 may include one or more hardware servers, server arrays, storage devices and/or systems, etc. In some implementations, the servers 118 and/or 122 may include one or more virtual servers, which operate in a host server environment.

The database 128 may be stored on one or more information sources for storing and providing access to data, such as the data storage device 208. The database 128 may store data describing client devices 106, user 110 profiles, instances of the selection application 108, media segments, composite data files, metadata, preferences, configurations, NFTs and/or power-ups, user wallet data, and other information, such as described herein.

A third-party server 118 can host services such as a third-party application (not shown), which may be individual and/or incorporated into the services provided by the management server 122. For example, the third-party server 118 may represent one or more item databases, forums, company websites, etc. For instance, a third-party server 118 may provide automatically delivered and processed data, such as frames, attributes, media segments, and/or services, such as media processing services, NFT-creating services, or other services.

It should be understood that the system 100 illustrated in FIG. 1 is representative of an example system and that a variety of different system environments and configurations are contemplated and are within the scope of the present disclosure. For instance, various acts and/or functionality may be moved from a server to a client, or vice versa, data may be consolidated into a single data store or further segmented into additional data stores, and some implementations may include additional or fewer computing devices, services, and/or networks, and may implement various functionality client or server-side. Further, various entities of the system may be integrated into a single computing device or system or divided into additional computing devices or systems, etc.

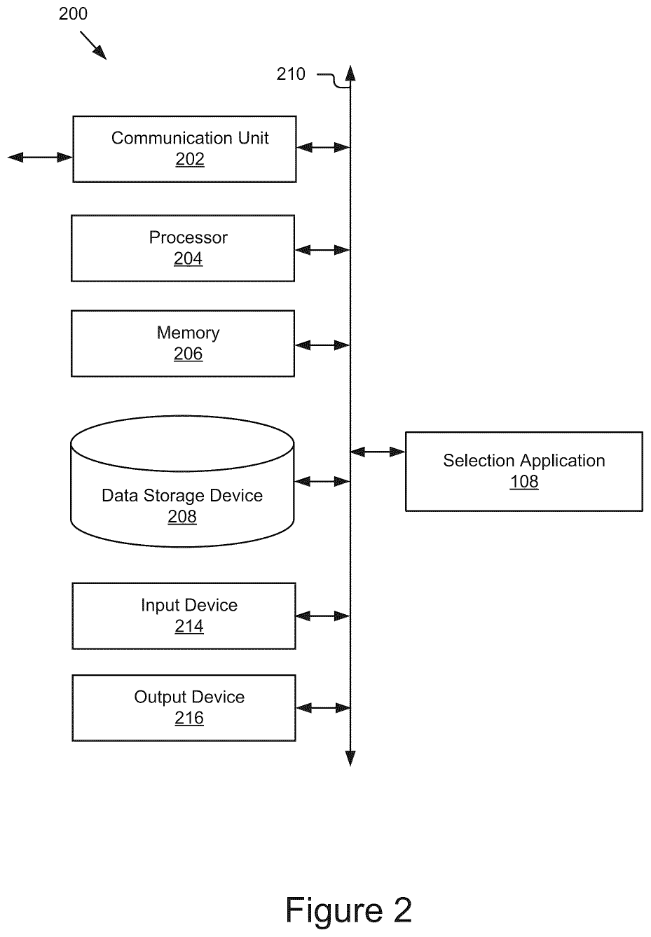

FIG. 2 is a block diagram of an example computing system 200, which may represent computer architecture of a client device 106 and/or another device described herein, depending on the implementation. In some implementations, as depicted in FIG. 2, the computing system 200 may include a selection application 108, or another application, depending on the configuration. For instance, a client device 106 may include or execute a selection application or components thereof, although other configurations are also possible and contemplated.

The selection application 108 includes computer logic executable by the processor 204 on a client device 106 to provide for user interaction, receive user input, present information to the user via a display, such as a GUI layout with one or more interactive elements, and send data to and receive data from the other entities of the system 100 via the network 102. In some implementations, the selection application 108 may generate and present user interfaces based on information received from the enterprise application 126, third-party server 118, and/or the web server 124 via the network 102. For example, a user 110 may use the selection application 108 to perform the operations described herein. In some implementations, the selection application 108 may present a radial slider for a user 110 to make various selections or inputs on as described herein. The radial slider may be a GUI interface that allows the user 110 to make selections of various clustered, real-time event data by making a selection (e.g., tapping, touching, selection) one or more GUI elements of the radial slider and then sliding from the selected element to a different GUI element of the radial slider to perform various operations, such as selecting a single GUI element, selecting multiple GUI elements, etc.). In some implementations, the selection application 108 may be configured to access one or more prepared GUI layouts from memory 206, populate the GUI layout based on instructions from the activity application 126, and/or present the GUI layouts with the populated information to a user 110. In further implementations, the selection application 108 may be configured to generate one or more GUI layouts and present the generated GUI layouts for a user 110 to view.

As depicted, the computing system 200 may include a processor 204, a memory 206, a communication unit 202, an output device 216, an input device 214, and/or a data storage device 208, which may be communicatively coupled by a communication bus 210. The computing system 200 depicted in FIG. 2 is provided by way of example and it should be understood that it may take other forms and include additional or fewer components without departing from the scope of the present disclosure. For instance, various components of the computing devices may be coupled for communication using a variety of communication protocols and/or technologies including, for instance, communication buses, software communication mechanisms, computer networks, etc. While not shown, the computing system 200 may include various operating systems, sensors, additional processors, and other physical configurations. The processor 204, memory 206, communication unit 202, etc., are representative of one or more of these components.

The processor 204 may execute software instructions by performing various input, logical, and/or mathematical operations. The processor 204 may have various computing architectures to method data signals (e.g., CISC, RISC, etc.). The processor 204 may be physical and/or virtual and may include a single core or plurality of processing units and/or cores. In some implementations, the processor 204 may be coupled to the memory 206 via the bus 210 to access data and instructions therefrom and store data therein. The bus 210 may couple the processor 204 to the other components of the computing system 200 including, for example, the memory 206, the communication unit 202, the input device 214, the output device 216, and the data storage device 208.

The memory 206 may store and provide access to data to the other components of the computing system 200. The memory 206 may be included in a single computing device or a plurality of computing devices. In some implementations, the memory 206 may store instructions and/or data that may be executed by the processor 204. For example, the memory 206 may store one or more of the enterprise application 126, the web server 124, the selection application 108, and their respective components, depending on the configuration. The memory 206 is also capable of storing other instructions and data, including, for example, an operating system, hardware drivers, other software applications, databases, etc. The memory 206 may be coupled to the bus 210 for communication with the processor 204 and the other components of computing system 200.

The memory 206 may include a non-transitory computer-usable (e.g., readable, writeable, etc.) medium, which can be any non-transitory apparatus or device that can contain, store, communicate, propagate or transport instructions, data, computer programs, software, code, routines, etc., for processing by or in connection with the processor 204. In some implementations, the memory 206 may include one or more of volatile memory and non-volatile memory (e.g., RAM, ROM, hard disk, optical disk, etc.). It should be understood that the memory 206 may be a single device or may include multiple types of devices and configurations.

The bus 210 can include a communication bus for transferring data between components of a computing device or between computing devices, a network bus system including the network 102 or portions thereof, a processor mesh, a combination thereof, etc. In some implementations, the enterprise application 126, web server 124, selection application 108, and various other components operating on the computing system/device 100 (operating systems, device drivers, etc.) may cooperate and communicate via a communication mechanism included in or implemented in association with the bus 210. The software communication mechanism can include and/or facilitate, for example, inter-method communication, local function or procedure calls, remote procedure calls, an object broker (e.g., CORBA), direct socket communication (e.g., TCP/IP sockets) among software modules, UDP broadcasts and receipts, HTTP connections, etc. Further, any or all of the communication could be secure (e.g., SSH, HTTPS, etc.).

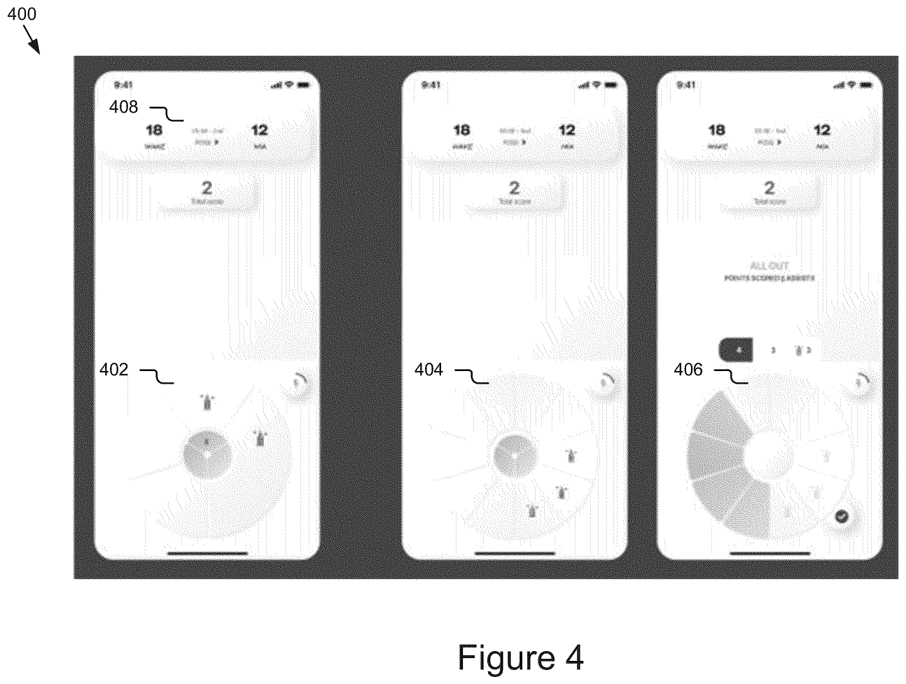

FIGS. 4-14 illustrate various example graphical user interfaces for providing the displays and interactions described herein. The communication unit 202 may include one or more interface devices (I/F) for wired and wireless connectivity among the components of the system 100. For instance, the communication unit 202 may include, but is not limited to, various types known connectivity and interface options. The communication unit 202 may be coupled to the other components of the computing system 200 via the bus 210. The communication unit 202 can provide other connections to the network 102 and to other entities of the system 100 using various standard communication protocols.

The input device 214 may include any device for inputting information into the computing system 200. In some implementations, the input device 214 may include one or more peripheral devices. For example, the input device 214 may include a keyboard, a pointing device, microphone, an image/video capture device (e.g., camera), a touch-screen display integrated with the output device 216, etc. The output device 216 may be any device capable of outputting information from the computing system 200. The output device 216 may include one or more of a display (LCD, OLED, etc.), a printer, a haptic device, audio reproduction device, touch-screen display, a remote computing device, etc. In some implementations, the output device is a display which may display electronic images and data output by a processor of the computing system 200 for presentation to a user, such as the processor 204 or another dedicated processor.

The data storage device 208 may include one or more information sources for storing and providing access to data. In some implementations, the data storage device 208 may store data associated with a database management system (DBMS) operable on the computing system 200. For example, the DBMS could include a structured query language (SQL) DBMS, a NoSQL DMBS, various combinations thereof, etc. In some instances, the DBMS may store data in multi-dimensional tables comprised of rows and columns, and manipulate, e.g., insert, query, update and/or delete, rows of data using programmatic operations.

The data stored by the data storage device 208 may be organized and queried using various criteria including any type of data stored by them, such as described herein. For example, the data storage device 208 may store the database 128. The data storage device 208 may include data tables, databases, or other organized collections of data. Examples of the types of data stored by the data storage device 208 may include, but are not limited to, the data described with respect to the figures, for example, the data may include user accounts, media segments, media providers, rarity levels, wallet data, blockchain data, etc.

The data storage device 208 may be included in the computing system 200 or in another computing system and/or storage system distinct from but coupled to or accessible by the computing system 200. The data storage device 208 can include one or more non-transitory computer-readable mediums for storing the data. In some implementations, the data storage device 208 may be incorporated with the memory 206 or may be distinct therefrom.

The components of the computing system 200 may be communicatively coupled by the bus 210 and/or the processor 204 to one another and/or the other components of the computing system 200. In some implementations, the components may include computer logic (e.g., software logic, hardware logic, etc.) executable by the processor 204 to provide their acts and/or functionality. In any of the foregoing implementations, the components may be adapted for cooperation and communication with the processor 204 and the other components of the computing system 200.

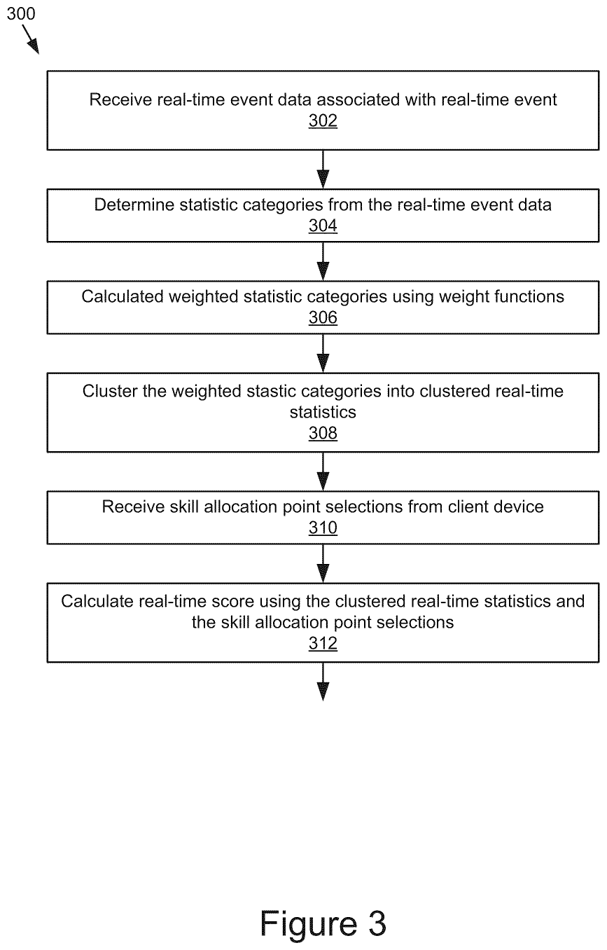

FIG. 3 illustrates a flowchart of an example method 300 for generating clustered real-time event data by the activity application 126 and calculating a real-time score based on one or more selections of a user 120 that relies on clustered real-time event data. It should be noted that other operations, orders, and features are contemplated herein. For instance, the technology may use fewer, additional, or different operations or orders of operations than those described herein without departing from the scope of this disclosure. It should be noted that although the operations of the method 300 are described in reference to the selection application 108, they may be performed by different components of the system 100, distributed, or otherwise modified without departing from the scope of this disclosure.

As shown in block 302, the activity application 126 may receive real-time event data associated with a real-time event, such as a sporting event, live televised event/show, live performance, etc. The real-time event data may be associated with statistics that can be measured and tracked for an event. Such as for a sporting event like basketball, the real-time event data may include the following example categories: points, blocks, fouls, possession time, shooting percentage, three pointers, shot positions, etc. In some implementations, the real-time event may provide the tracked real-time event data, while in further implementations, the activity application 126 may parse out the real-time event data. It should be understood that real-time refers to the time it takes for trackable statistic to occur during the event, be captured and logged as a statistic and provided to the activity application 126 and instead may be referred to as substantially real-time. However, the data is captured in substantially real-time so a user would not get the benefit of receiving a data update and changing a selection before the activity application 126 has logged the event data. In some implementations, the activity application 126 may perform various synchronization to line up selections and/or changes to various selected categories from a user 110 with occurrences of a measured statistic during an event to synchronize the occurrences on both the client device 106 with substantially real-time events. For example, a user may make a change to a category to track blocks made by a team during a live event at a first time and the activity application 126 and/or the client device 106 may receive that selection from the selection application 108 and timestamp or mark that selection at the first time. At a second time that occurs shortly after the first time, a block may be measured as a statistic in the real-time event. The activity application 126 may identify and determine that the change made by the user 110 was timestamped to precede the second time of the measured statistic and provide appropriate scoring functions to the users 110 score based on the selection, even if because of data transmission delays and/or measured statistic scoring delays the change is received at the activity application 126 after the measured statistic has already been recognized.

At 304, the activity application 126 may determine statistical categories from the real-time event data. As described above, the real-time event data may be broken up into various statistical categories that can be measured occurrences as a real-time event, such as a sporting game is happening, such as the statistics themselves, e.g., points, blocks, fouls, possession time, shooting percentage, three pointers, shot positions, etc. or in further implementations, the statistical categories may be further grouped, such as grouping all fouls rather than separate fouls, or grouping defensive statistics, etc. In some implementations, the activity application 126 may also cluster various statistic at this point as well prior to weighting the statistic categories. In some implementations, clustering of the statistic may happen before or after weighting of the statistical categories occurs as described herein.

At 306 the activity application may calculate weighted statistic categories using weight functions. The weigh functions may be assigned for each statistical category such that dissimilar statistics can be compared. For example, a weighted function may be used to compare the average number of points in a game to the average number of blocks in a game. Then using the weighted functions, these two dissimilar statistics can be compared head-to-head to determine overall user real-time scores as described herein. In some implementations, only some of the statistics are weighted, while in further implementations, all of the statistics may be weighted to be compared. In some implementations, machine learning or artificial intelligence may be used to weight the statistic categories in substantially real-time based on relevant previous statistical data, etc. In some implementations, these weighted may be generated based on modifiers from the activity application 126, for example, not all of the statistical groupings may be weighted 1:1 but instead more weight may be applied to certain statistic categories pre clustering or modifying by power-ups, etc.

In some implementations, the activity application 126 may be configured to update the weights of one or more statistical categories based on one or more criteria, such as a change in the game like a player getting injured or a new strategy being employed (like switching to a new defensive scheme, etc.). The activity application 126 may monitor the various weights of the stategories and detect a change in the balance of the various weighted statistic categories. In response to detecting the change in the balance, the activity application 126 may update the weighted statistic categories to change the balance. The activity application 126 may monitor the selections of various users 110 as they are making selections and having scores calculated during the real-time event and may adjust one or more weights to even out the various selection so one statistical category does not significantly outperform the other statistical categories or to keep the various scores within ranges that do not provide specific advantages by selecting one statistical grouping over another, etc. For example, in a basketball game, if the main defender of one of the teams is injured and leaves the event, the activity application 126 may assume that the real-time event game will end up having less blocks or other defensive statistics for the remainder of the event and will balance the various weights accordingly to still allow defensive point selections from users 110 to maintain competitiveness with the other selection options.

At 308, the activity application 126 may cluster one or more of the various weighted statistic categories into clustered real-time statistics. Clustering may group these different weighted statistic categories under a label/grouping that may then be selectable by a user in the selection application 108 and if any of the real-time data shows an increase in a stat from the clustered real-time statistics, it increases a real-time score of the user based on the label/grouping. For example, a first cluster grouping may be under the term “All Out” that relates to points, assists, and/or triple doubles during an event. A user 110 may select the “All Out” clustered real-time statistics and anytime points, assists, or triple doubles occur, the user's real-time score may increase based on the weighted values of the point, assist, or triple double. In another example, the label “Big Man” may refer to the clustered real-time statistics of rebounds, blocks, and an event ending under 90 points scored. In another example the label “Sniper” may cluster the real-time statistics of field goal percentage, three-pointers made, and under 90 points in a game. When these clustered real-time event statistics are scored, the activity application 126 may look at both if a clustered real-time event statistic was selected when an occurrence of the statistic happened in a real-time event, as well as potentially how long one or more of the clustered real-time event statistics and adjust various scores based on the selection data such as time the clustered real-time event statistic was selected, if the clustered real-time event statistic was selected during an occurrence, likelihood of various statistics actually occurring separate from the weighting function to provide additional rewards to select more of a low probability selection strategy, etc.

By using these clustered real-time statistics, the activity application 126 combines various statistical categories in a way that makes it engaging for a user to select different stats for a real-time score. This is an improvement on conventional micro-betting or other types of real-time event interactions because it allows the user 110 to be more engaged instead of just picking a single stat and placing a bet on a value/chance of that stat occurring. This clustering of the real-time statistics makes the less probable events, such as triple doubles more engaging as they are also tied into more common stats occurring and having all of the real-time event data be weighted appropriately. This unique way of combining different statistics under a clustered real-time statistic label that is unique and engaging provides a new way of interacting with a real-time event compared to micro-betting or even sports betting in general.

At 310, the activity application 126 receives one or more skill allocation point selections from a client device 106. The user 110 may select one or more labels representing clustered real-time statistics for point tracking and when the real-time statistics reflect an increase in one or more of the clustered real-time statistics, the activity application 126 may compare those increases to the skill allocation point selections for one or more users 110. At 312, the activity application 126 may then calculate a real-time score using the clustered real-time statistics and the skill allocation point selections. For example, a user 110 may have selected from an existing pool of five skill allocation points and put all of the skill allocation points on the clustered real-time statistic labeled “Big Man”. When a rebound occurs in real-time in the event, the activity application determines the weighted value of that rebound under the clustered real-time statistic and then also determines how that value changes when the user has selected the “Big Man” label five times, e.g., a modifier such as a 5× increase in the weighted value of the rebound may be used to calculate a current real-time score for the user 110. The current real-time score of the user 110 may be compared to current real-time scores of other users 110 to show which user currently has the high/winning score based on their skill point allocations and the clustered real-time statistics.

Compared to regular micro-betting, a user 110 can change a skill allocation in real time during the event, such as by deselecting two of the “Big Man” selections and instead selecting two of the “Sniper” selections. This means the user 110 would currently have skill allocations for three “Big Man” clustered real-time statistics and two “Sniper” clustered real-time statistics. These skill allocation selections allow users to change their strategy as the event is playing out, and also tracking the real-time scores of other users that have allocated various skill allocation selections differently. It opens up the opportunity for many more configurations for placing bets or gamification of the skill allocation points during the event. This solution provides a new way for users to interact with live events beyond placing simple micro-bets and provides for gamification of the community. For example, users 110 can all participate within a same group at a sports bar during a basketball game. They can select their skill point allocations and see their current real-time scores in the application compared to the other users 110 in the group at the sports bar, etc. The ability to make simple changes to the skill tree allocation that can have varying changes to the different calculated real-time scores allows for much more engagement, playability, and interactions compared to simple micro-betting.

FIG. 4 illustrate various example graphical user interfaces 400 for providing the displays and interactions described herein. As shown in FIG. 4, the GUI 402 shows a selection of five different selection element areas around a radial slider where skill points can be allocated. At a top of the GUI a current score 408 of the real-time event is shown and below that a box with the value “2” indicates the user's current real-time score that is updated as the real-time event progresses and different clustered real-time statistical categories are selected. A user 110 can interact with the radial slider as shown in GUI 404 to select different skill allocations that reflect different clustered real-time statistical categories as described elsewhere herein. As shown in GUI 404, the user has selected three out of ten skill point allocations with one type of label, such as Big Man, Sniper, etc. In GUI 406, a user is currently selection additional skill point allocations out of the ten total. The skill point allocations provide various modifiers, such as to multiply a value of a statistic based on the selection. Being able to allocate various skill points over various clustered statistical categories provides for almost limitless configurations for calculating real-time scores of users. Additionally, since users can modify the skill point allocations in real-time, based on events in the game, the user 110 can change their skill point allocations. For example, if a team in a basketball game subs out a bunch of taller players for more shooters, the user 110 can switch from a rebound and defense specific skill point allocation to one based on points and/or assists to try and capitalize on the change of the player lineup in the game.

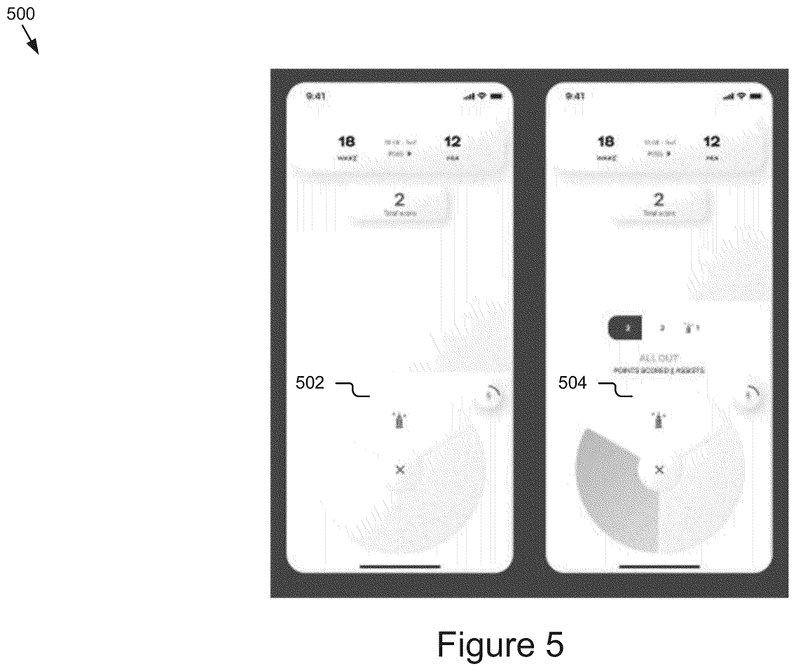

As shown in FIG. 5, example GUIs 500 may show additional selections from a user 110. For example, a user 110 may tap or select an area of a skill point interface to select different skill tree allocations. A skill tree allocation may be a graphical depiction of the clustered, weighted real-time event data. A user 110 may select different graphical depictions to intuitively switch between different clustered and weighted real-time event data selections. As shown in GUI 502, no skill points have been selected yet, but the category (denoted by the building icon representing the “Big Man” label) has been selected and up to three skill points can be allocated for this category. As shown in GUI 504, a first skill point has been allocated by the area being highlighted or changing color and additional skill points can be allocated or the user 110 can change category and allocate the last two remaining skill points to a different label of clustered real-time statistics. In some implementations, a user 110 may select one or more elements presented on an output device 216, such as a display of the client device 106 such as by using a touchscreen or other input device 214 to make a selection of one or more graphical elements.

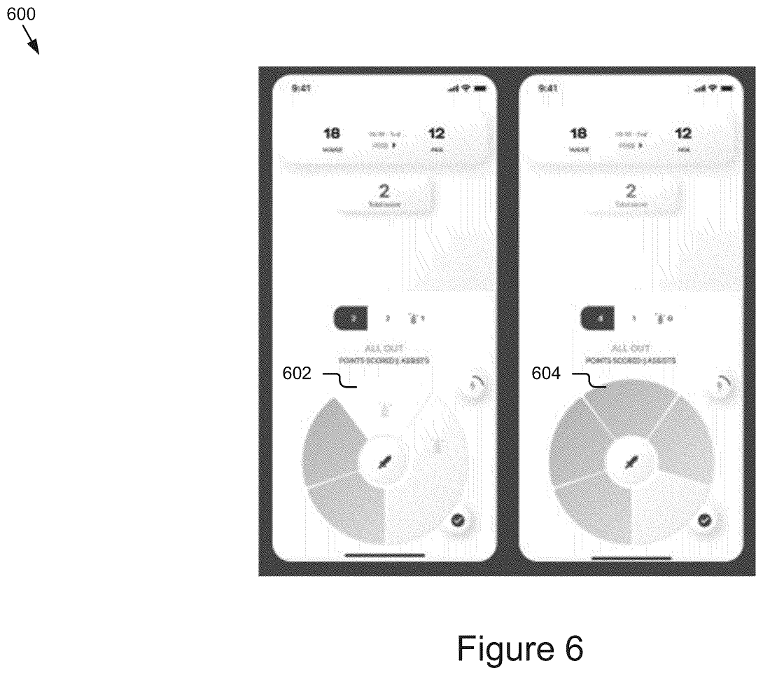

As shown in FIG. 6, example GUIs 600 may show additional selections from a user 110. For example, the GUI 602 may reflect that the user 110 has selected two skill points out of five for an offense based cluster label (denoted by the sword icon as a graphical element of one or more clusters of weighted real-time event data). In GUI 604, the user 110 may select an additional two skill points to be allocated for four skill points out of the total five as shown by the highlighted or color changed areas.

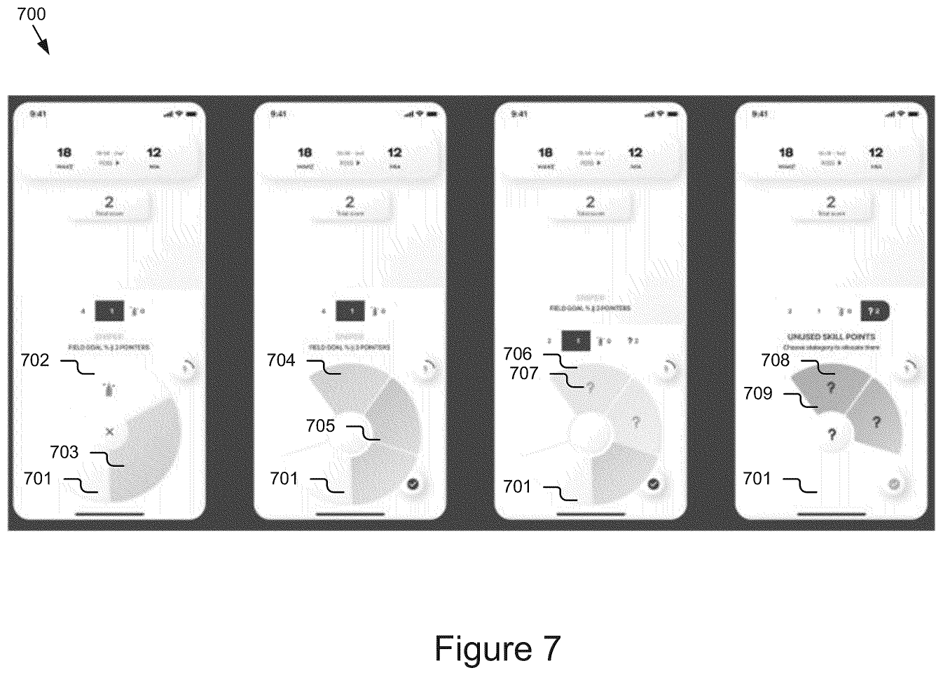

As shown in FIG. 7, example GUIs 700 may show additional selections from a user 110. In some implementations, the skill point allocation may be performed by a radial slider which represents a graphical element 701 that allows a user 110 to select a point and drag around a center point (such as clockwise) to increase skill point allocation and/or select a point and drag around the center point (such as counter-clockwise) to decrease a skill point allocation. It should be understood that these examples of how to increase and/or decrease a selection by a user 110 do not limit the ability of the radial slider to be used in other implementations. As shown at GUI 702, a user selects a skill point area shown by the highlighted section 703 and then drags an input counter-clockwise around the center point as shown in GUI 704 to select a total of three skill point allocation areas as represented by the highlighted areas 705. In this implementation, moving counter-clockwise decreases the skill point allocations and as shown in GUI 706, additionally, in this implementation, the selections of various graphical elements are removed and where no skill points have been allocated, an icon 707 appears, such as a “?” to indicate to a user 110 that a selection of skill point allocations can be made. At GUI 708, the unused skill points may be flagged with additional highlighting 709 to indicate to a user 110 that a selection can be made. As shown in this example, using a radial slider to increase and/or decrease skill point allocations allows for an engaging way for a user 110 to input a selection and allows for that input to be performed with a single input that taps and then rotates. In other implementations, other input options for skill point allocation are also contemplated.

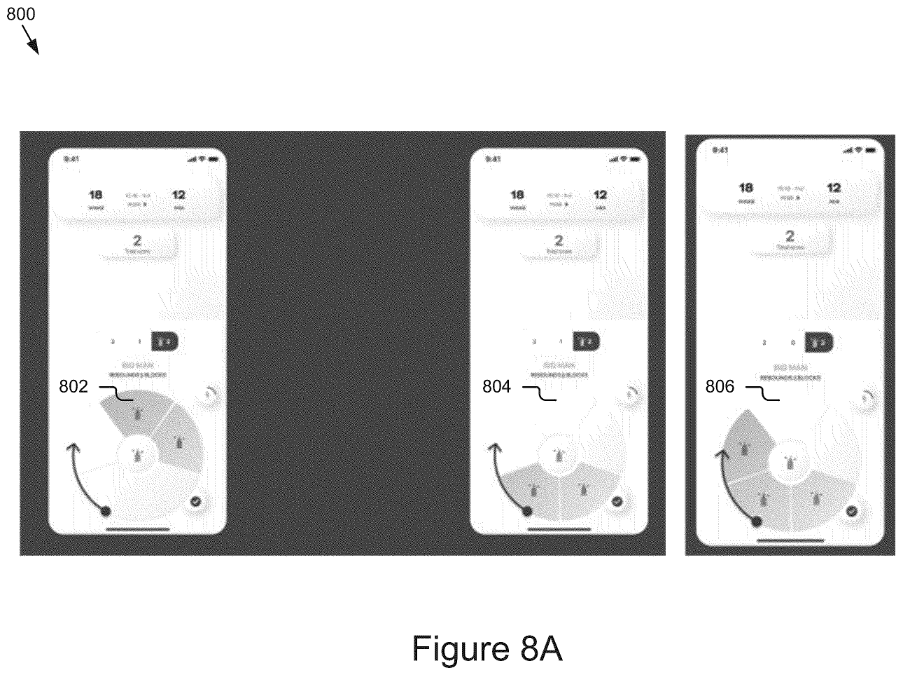

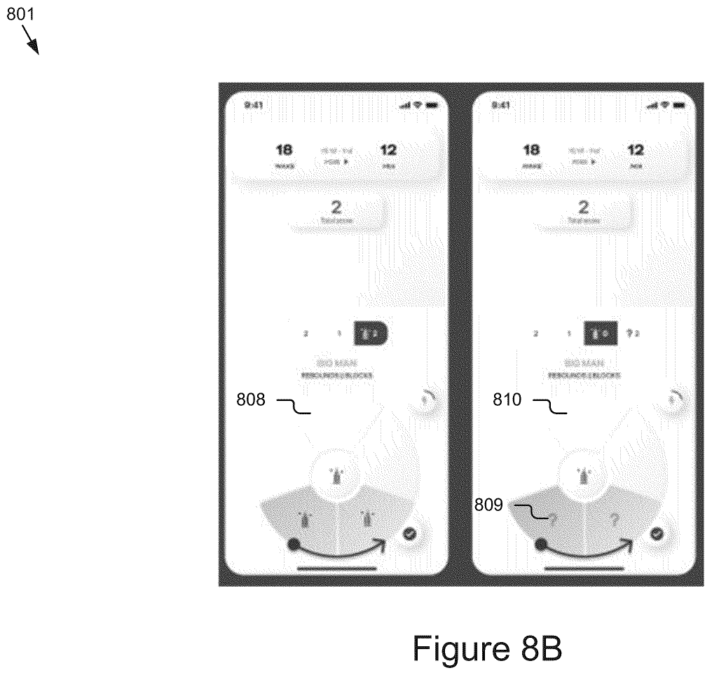

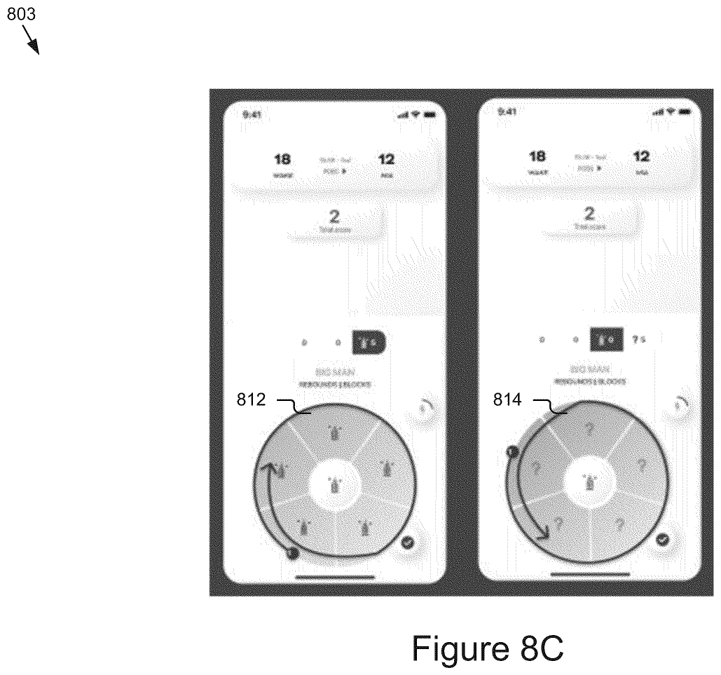

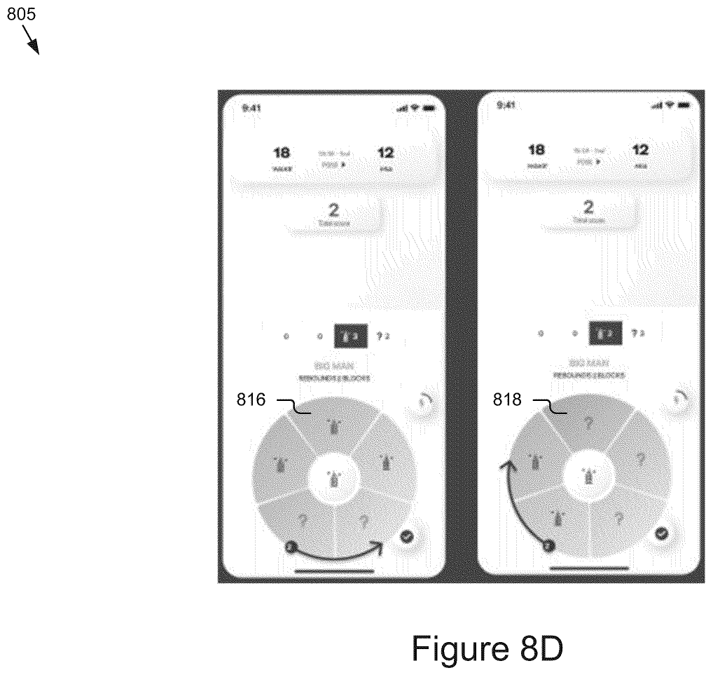

As shown in FIG. 8A, example GUIs 800 may show additional selections from a user 110. In some implementations, as shown in FIGS. 8A-8D a radial slider 802 may be used for skill point allocation. As shown in FIG. 8A, when a user 110 selects a tile that is not already assigned for skill point allocation, the previously allocated tiles rotate along the radial slider 802 as shown in the updated radial slider 804 to allow the user to continue adding skill point allocations in the same category using the radial slider motion in a clock-wise direction. This action of grouping the allocations on the radial slider allows for a user 110 to intuitively see how many skill points have already been allocated and apply additional skill points using the rotating motion on the radial slider. As shown in further updated radial slider 806, when a user 110 moves the selection clockwise it increase the skill point allocation. It should be understood that the radial slider is not limited to a clockwise or counter-clockwise mode of adding selections, but instead may employ additional features for selecting graphical elements such as selecting individual elements, inputting a quantity for a selection, filling out bars in a horizontal or vertical alignment, placing characters and/or digital items into a deployment area, etc.

As shown in FIG. 8B, example GUIs 801 may further show additional selections from a user 110 on a radial slider. In the example radial slider 808, when the user 110 instead moves the selection counter-clockwise it decreases the skill point allocation. As shown in radial slider 810, the decreased skill points may instead be shown with questions mark icons 809 to indicate that the skill points have been removed.

As shown in FIG. 8C, example GUIs 803 may further show additional selections from a user 110 on a radial slider. In the example, when a user selection exceeds a full circle (e.g., 360 degrees around a center point) then the additional inputs going clockwise to increase as shown in radial slider 812 or inputs going counter-clockwise to decrease as shown in radial slider 814 can be ignored as the radial slider inputs have been fully selected.

As shown in FIG. 8D, example GUIs 805 may further show a show a direction change in the input on the radial slider. As shown in radial slider 816, a user 110 starts a 360 degree swipe in one direction (counter-clockwise) then changed directions (clockwise) in radial slider 818 while maintain contact with the touchscreen or other input device 214. The direction change is treated by the selection application 108 as the origin of the initial rotation and the radial slider determines the skill point allocation (since it's a clockwise direction change) from the point of change.

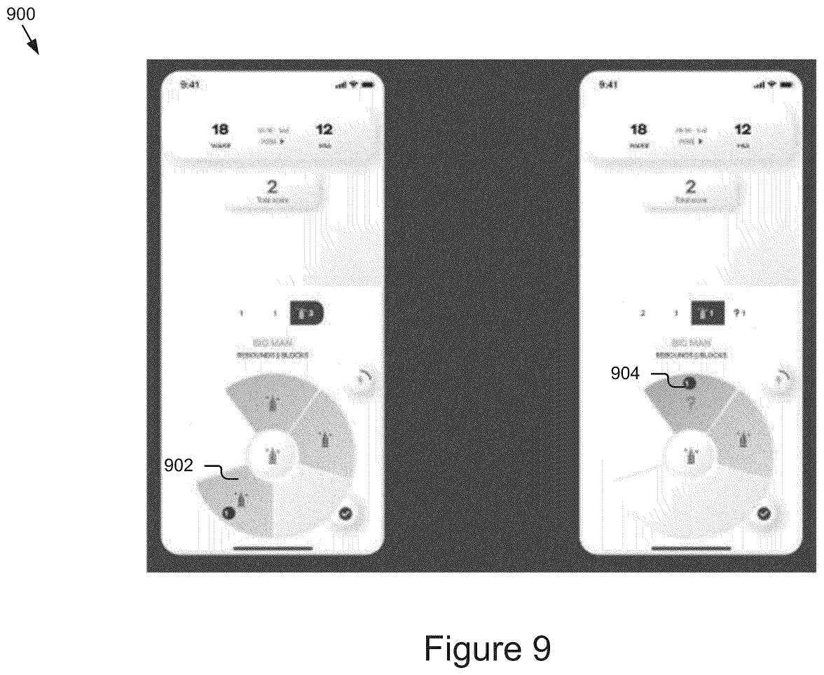

In some implementations, as shown in FIG. 9, example GUIs 900 may further show a selection by a user 110. As shown in the example, a user 110 tap may be used for skill point allocation. As shown in radial slider 902, a user 110 may tap an unselected area representing an individual skill point and a skill point may be allocated to that area. In some implementations, once the skill point has been allocated, the skill points may also automatically be rearranged and grouped around the center point. As shown in radial slider 904, if a user 110 tap is on a previously selected skill point area, then that skill point will be removed and replaced with an empty icon on that skill point area.

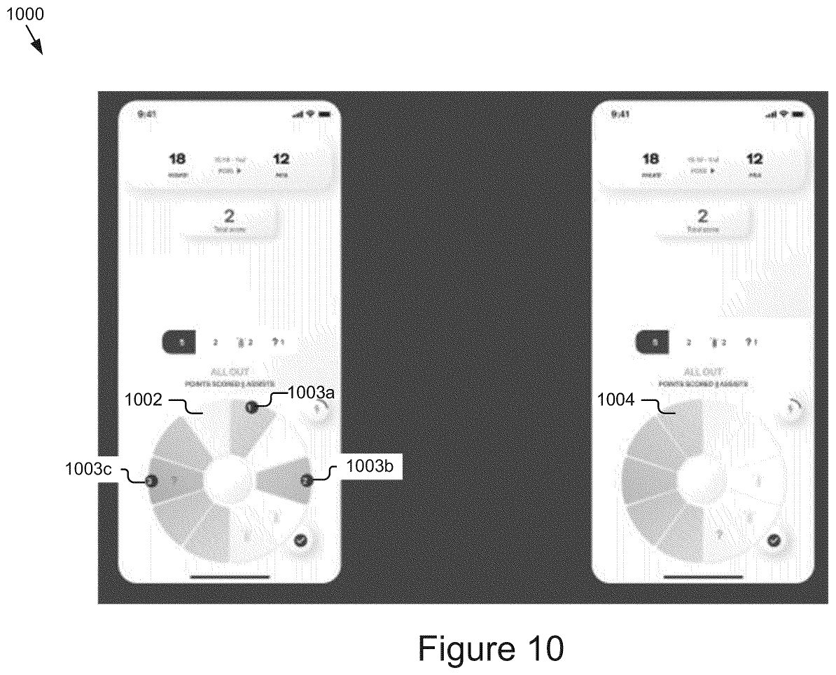

In some implementations, as shown in FIG. 10, example GUIs 1000 may further show a selection by a user 110. In the example, a user 110 may provide multiple input taps as shown in GUI 1002 at input taps 1003a-1003c. In the example, input tap 1003a and input tap 1003b show input taps on empty areas to add a skill point allocation. Input tap 1003c shows an input tap on a previously allocated area to removed the skill point allocations. As shown in GUI 1004 once the inputs have been processed, the skill points can be regrouped or reorganized around the center point into a group adjacent to similar skill points that are allocated.

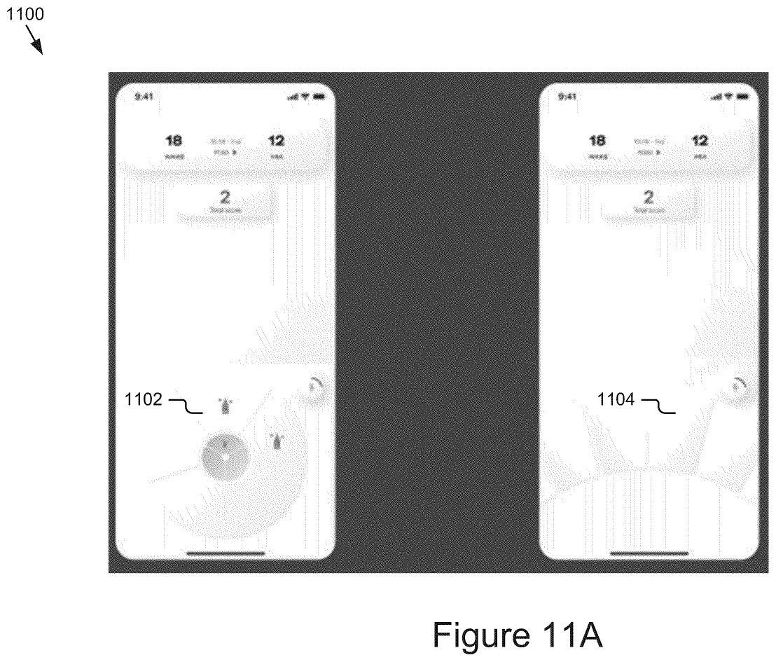

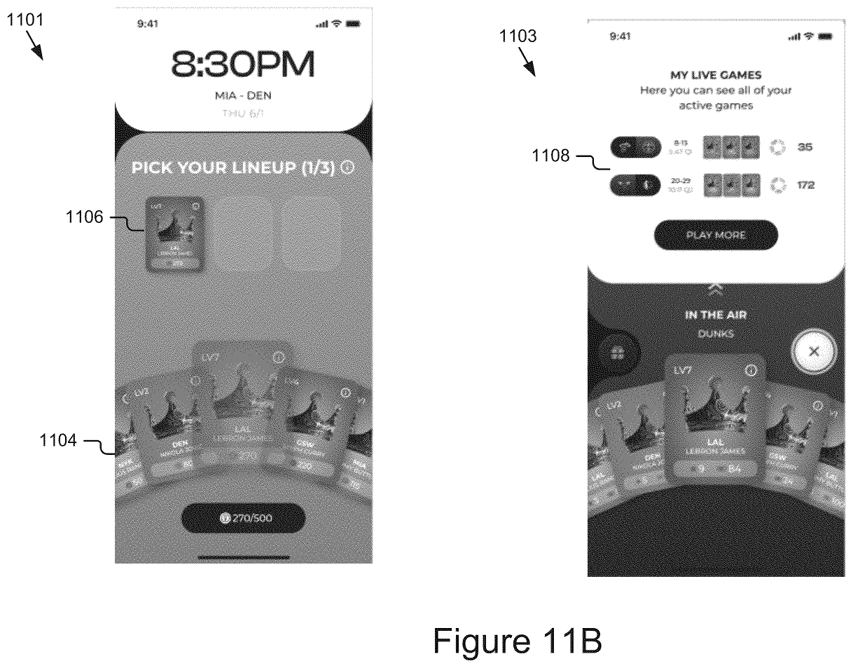

In some implementations, as shown in FIG. 11, example GUIs 1100 may further show a selection by a user 110. As shown in FIG. 11, the skill point allocation may be shown in a collapsed view as shown in GUI 1102. In further implementations, the skill point allocation can depict an expanded view as shown in GUI 1104 and a user can view various selections. In the expanded view, additional details can be provided upon selection of a skill point allocation and in implementations where large amounts of skill points are being allocated, the expanded view may provide additional detail compared to the collapsed view.

In some implementations, additional power-ups may also be selected by a user 110 to further modify a real-time score of the user. For example, a power-up may be selected by a user 110 that further increases a score gain for a period of time, such as thirty seconds. A user 110 may have a collection of various power-up items that the user 110 may deploy in different instances. In some implementations, the power-up items may be further tied to specific weighted statistics or clustered weighted statistics and the statistic occurring in the real-time event provides an additional score increase for the real-time score of the user 110. For example, a power-up titled “In The Air” may be selected by a user that provides additional points for a time period (such as thirty seconds) for every dunk that occurs in the real-time event while the power-up is active. These power-ups may be collected and used by users 110 at various times during the real-time events in order to provide even more engagement and changes.

In some implementations, these power-ups may be specific collectibles, such as NFTs or other tokenized assets that a user 110 has previously collected. In some implementations, the activity application 126 may have additional metadata related to the NFT owned by the user 110 that allows the NFT to be used as a power-up with specific in-application benefits when used. This provides an additional value to various NFTs on the market and provides a collectible function for users 110 that collect and use these NFTs as power-ups from the selection application 108.

As shown in GUI 1101 of FIG. 11B, a user 110 can select various power-ups 1104 from a vault or collection of power-ups available to the user 110. In some implementations, a user 110 may be able to select a power-up lineup 1106 from the power-ups in their vault. In some implementations, as shown in GUI 1103, the power-ups may have some item management characteristics, where for example, the power-ups could not be deployed simultaneously in two concurrently occurring matches 1108, but instead the user 110 would have to select which match to play and then only the cards in the round could be played in that feature. In some implementations, power-ups may have upgradable features that allow them to progress and increase in value. In some implementations, the user may upgrade one or more stategories to include sub-categories, such as an initial dunk category and sub-categories of “two-handed”, “alley-oop”, “tomahawk”, etc. and the user may add updated scoring options based on the unlocked sub-categories. In some implementations, as these power-ups are upgraded, the value of the power-up increases and there is some tradability/collectability value for these upgraded power-ups.

In some implementations, power-ups may have various budgets or salaries to be used. For example, the power-ups may have cost to play, such as an energy cost, a decrease in stamina per use cost, a token cost, etc. and the user 110 has to balance the cost to use the power-up with any potential rewards that would come from using the power-up. In some implementations, power-ups or other tokens can be rented out for other users to purchase or borrow.

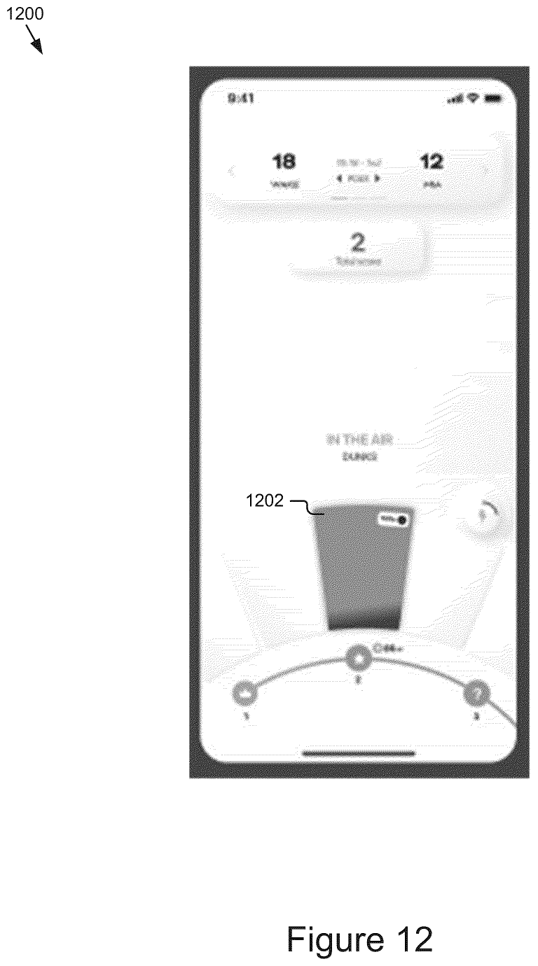

FIG. 12 shows an example GUI 1200 that depicts an example of a user selectable power-up. As shown in the example, a GUI presents a selection 1202 by a user 110 of a power-up depicted as a card in this example from a variety of displayed power-ups. In some implementations, as shown in GUI 1202, these power-ups may also have various progress features that may increase their capabilities over time. As shown in the selection 1202, that progress features appears as a progress bar below the power-up. In some implementations, these power-ups may have different rarities and values that are additionally assigned to the NFT. For example, if a user 110 uses a specific NFT power-up three times, the power-up unlocks a new level that increases the duration of the power-up, etc. By combining the collectability of the NFTs with the ability to change various functions of the real-time score of a user, the value and appeal of various NFTs also increases as they can be leveled up and used by users 110 at various times to increase their real-time scores.

In some implementations, additional power-ups may be based on geo-location specific information. For example, users that attend a sporting event in person and also login to the selection application 108 may receive a bonus to their modifiers while attending in person. In other implementations, they may receive various power-ups, tokens, unique NFTs, etc. based on logging in while also being in a specific location. In another implementation, a sports bar or other location may have a paid promotion that provides various power-ups, modifiers, etc. for users 110 that participate in a real-time event while at that location, such as groups at the sports bar, etc. These location based features allow additional expandability of the game and provide for further community engagement as users 110 can compete against other users proximate to them while also enjoying real-time events.

In some implementations, a user 110 also has a user specific profile that can be leveled up as a user progresses. For example, as a user 110 participates in various events over time and competes against other users, the user 110 may receive specific unlocks as modifiers that change how their real-time score is calculated. For example, their power-ups may last longer durations, their skill points may be allocated in different configurations or earn more points, etc. As a user 110 progresses, their progress unlocks on their account which may allow the user 110 to be more competitive and have additional engagement in the application.

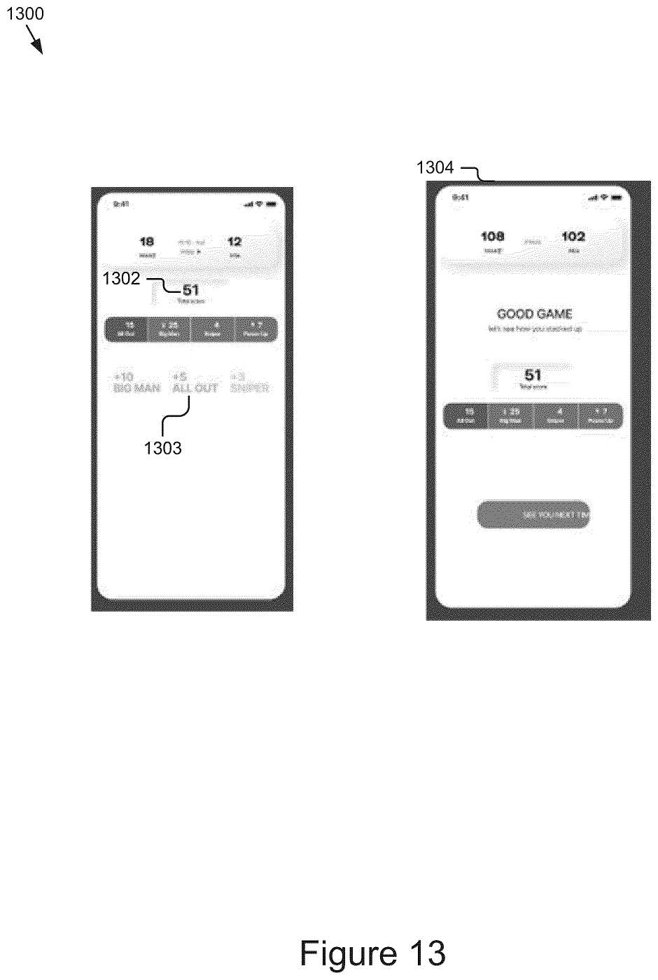

In some implementations, as shown in FIG. 13, example GUIs 1300 may further show a selection by a user 110. In this example, a GUI 1302 can depict current real-time score changes as a real-time event progresses. A user 110 can see where points are coming from 1303 based on their skill point allocation and reallocate/change the skill point configuration at any point during the real-time event. As shown in GUI 1304, when the real-time event ends, a final score is calculated for each user and the users ranking compared to other users is shown. In some implementations, the user ranking is a global ranking for all users that participated during the real-time event. In further implementations, the user 110 may be grouped with other users 110 and a smaller subset of the global users is how rankings are determined.

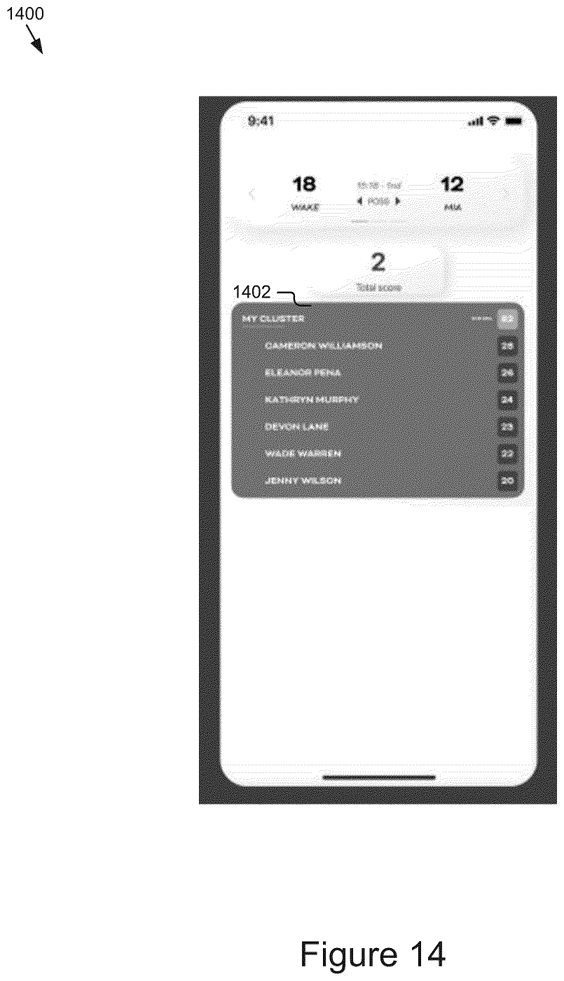

FIG. 14 shows an example GUI 1400 of a user ranking against other users in a group. As shown in FIG. 14, a user can compare their current real-time score to others in their group as shown in the ranking 1402. In some implementations, the activity application 126 may provide a social aspect to the application that allows users to interact with others in their group and/or see their real-time scores compared to others. In some implementations, users may be able to form their own groups to compete with friends, coworkers, etc. in social groups that they know.

In some implementations, a user 110 may also have access to a “coaching tree” from the selection application 108 that allows the user to customize various strategies throughout the real-time event. In further implementations, the “coaching tree” includes additional abilities that can be unlocked through progress during real-time events. As a user 110 interacts with the application over time, the user 110 can unlock and gain access to various modifiers and features that may provide additional ways to earn modifiers and points to change the real-time score of the user 110.

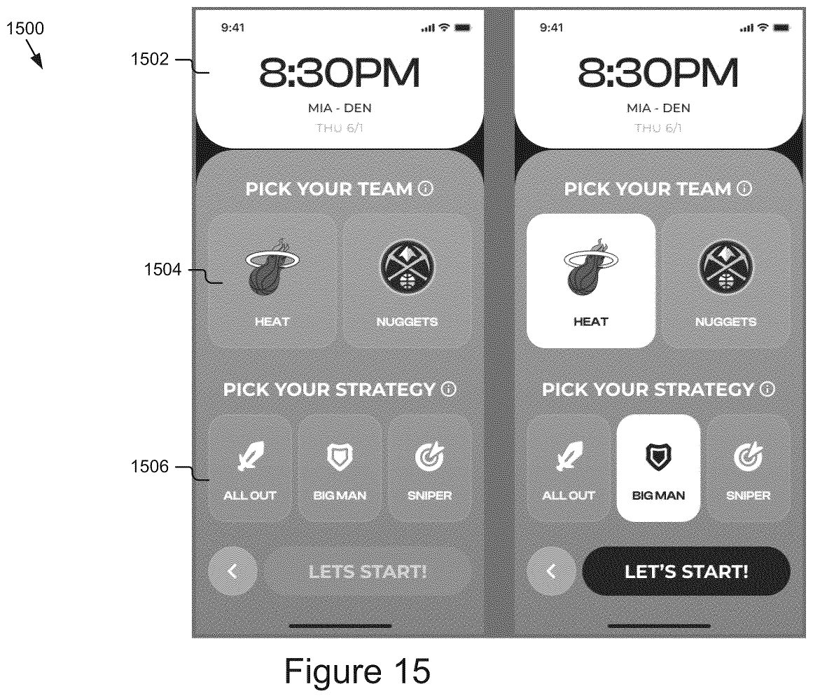

FIG. 15 depicts an example GUI 1500 of a user selection of a selectable clustered real-time event data. As shown in the example, a user 110 can be viewing a live event, such as a live sporting event like the NBA basketball game depicted in the example. The match details 1502 may include information about when an event will start, a date of the event, and what teams are participating in the event. A user 110 can be prompted to have an initial pick 1504a for a team in this example, although in other implementations, a user may instead pick a player, a squad, a participant, a specific statistic, a time period, or some other section that provides real-time event data for the live event. In some events a user 110 can also participate in rounds for microbetting, such as having a game go until the first round is over and having mini bets/rewards along with more detailed end game totals. It should be understood that an initial pick 1504 to limit statistic is also only being shown in this example and in other implementations, different selections criteria or even not have an initial pick 1504 are also contemplated. As shown, the user 110 may also be prompted to make a stategory pick 1506 where the user selects from one or more clustered statistics for scoring points. In some implementations, these clustered statistics are groupings of different statistics either in common or more unconventional pairings that may be weighted against each other to eliminate advantages. A user 110 can view in some instances what qualifies as a statistic in these scoring metrics. As shown in the example, when a user 110 makes a selection, the selections may be highlighted to indicate which selections a user 110 made.

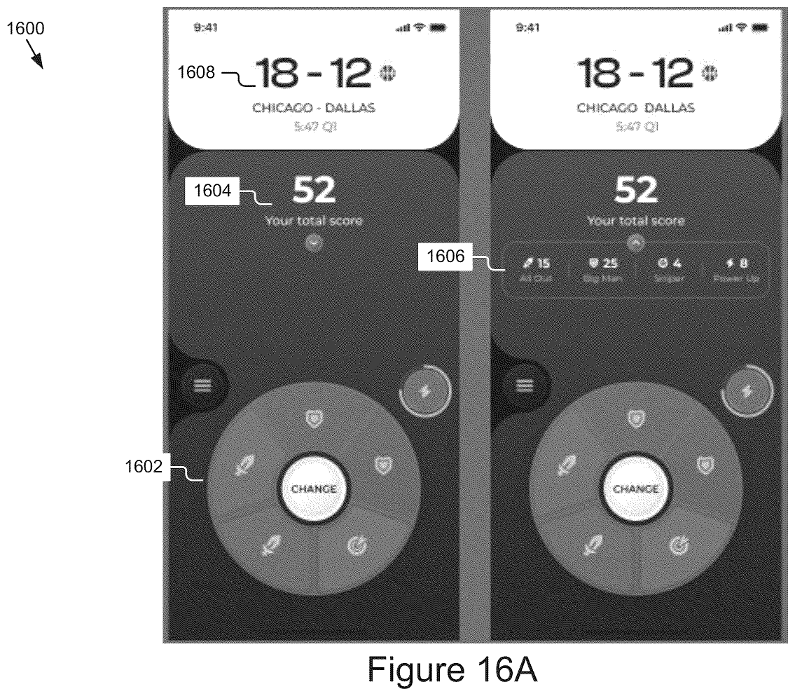

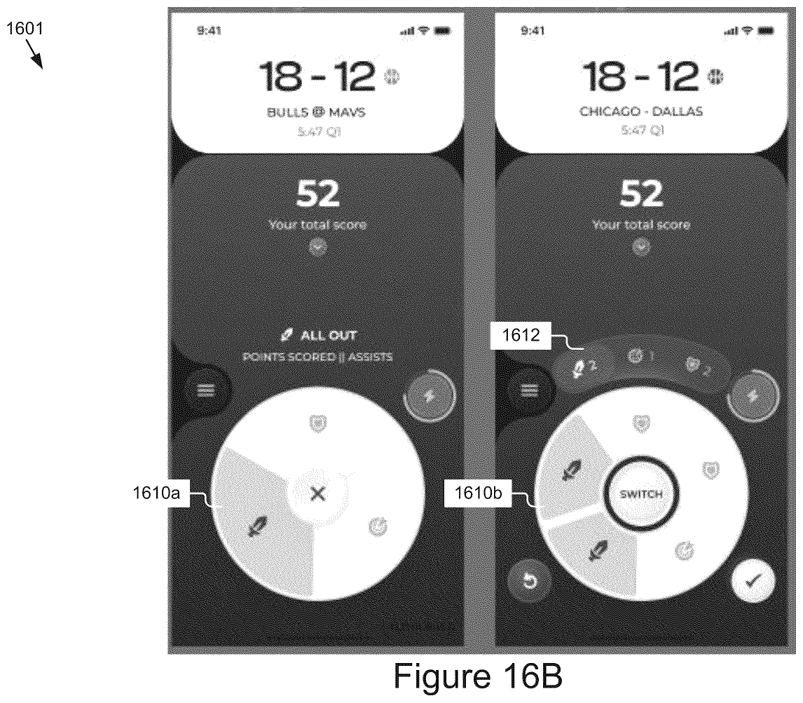

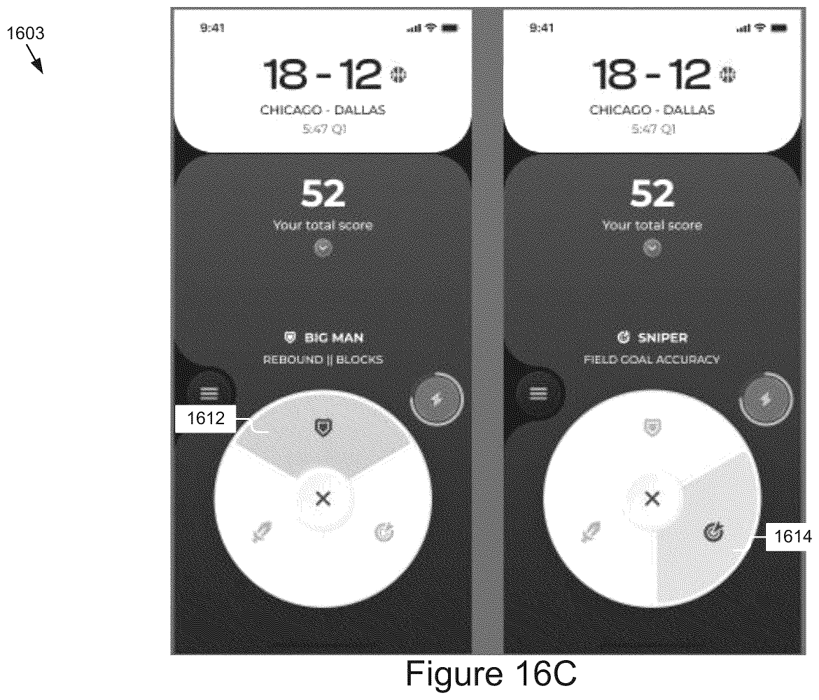

FIGS. 16A-16C depict an example GUIs for selecting clustered real-time event data. As shown in FIG. 16A, GUI 1600 depicts a main page for participating on one example of an application for scoring using weighted clusters of real-time event data. As shown in FIG. 16A, a user 110 can view a stategory selection wheel menu 1602 that allows a user to select different stategories for scoring. A user can also view their current score 1604 based on their selections as the real-time event score 1608 is also progressing. In some implementations, a user 110 can also view how their score is accumulated 1606 and what stategories are provided points to their current score 1604. A user 110 has the option based on viewing where the points are coming from of reallocating various stategory selections in real-time as the live-event progresses.

FIG. 16B illustrates a GUI 1601 depicting a user 110 making a change to a stategory selection. As shown, a user 110 has currently selected one stategory 1610a in the “all out” category and has updated that stategory 1610b to include two “all out” selections. The stategory breakdown menu 1612 shows where current stategories are allocated and a user 110 can update or change their selection of stategories in real-time as the live-event progresses.

FIG. 16C illustrates a GUI 1603 depicting a user 110 selecting different stategories “big man” 1612 and “sniper” 1614. The user 110 is able to view and change different stategories using the stategory selection wheel menu 1602 in order to adjust their selections during the live-event. This allows the user to monitor changes during the live-event, such as different players being substituted into the game and adjusting their selections in substantially real-time based on predictions about how the game will adjust to the new players. This provides a unique benefit over rigid conventional sports betting as the user can react to changes in real-time and adjust to a strategy that may not have been accounted for before the live-event began. It also provides a more immersive experience for the user 110 to feel involved in the activity.

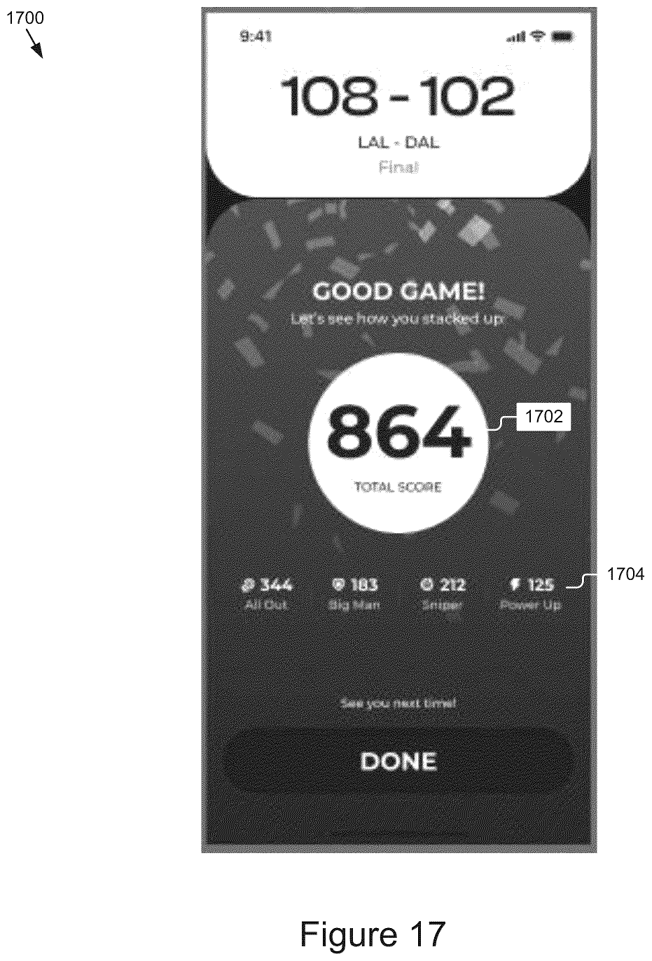

FIG. 17 depicts an example GUI 1700 of an end game screen. A user 110 can view their total score 1702 and see that total score breakdown 1704 based on the different stategories they selected. By selecting different clustered weighted real-time event data for scoring the game is dynamic and harder for a user to predict how the scores will end up, since the variety of different variables that are weighted can make very different adjustments to the score. Additionally, the weights for the data can be adjusted in substantially real-time and/or by an AI or machine learning algorithm so the stategory outputs for scoring may change as the live event progresses.

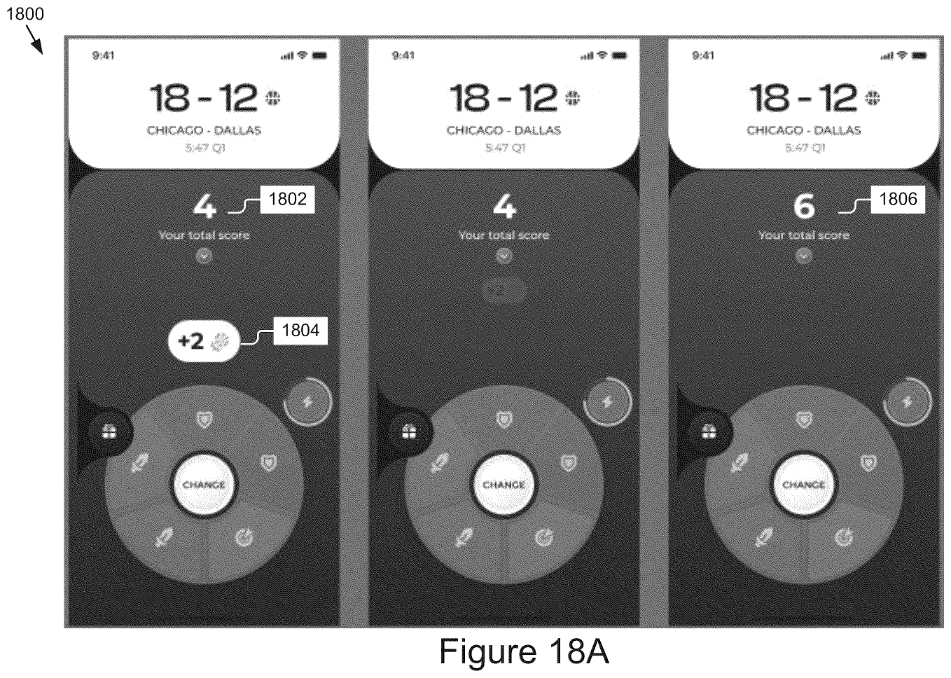

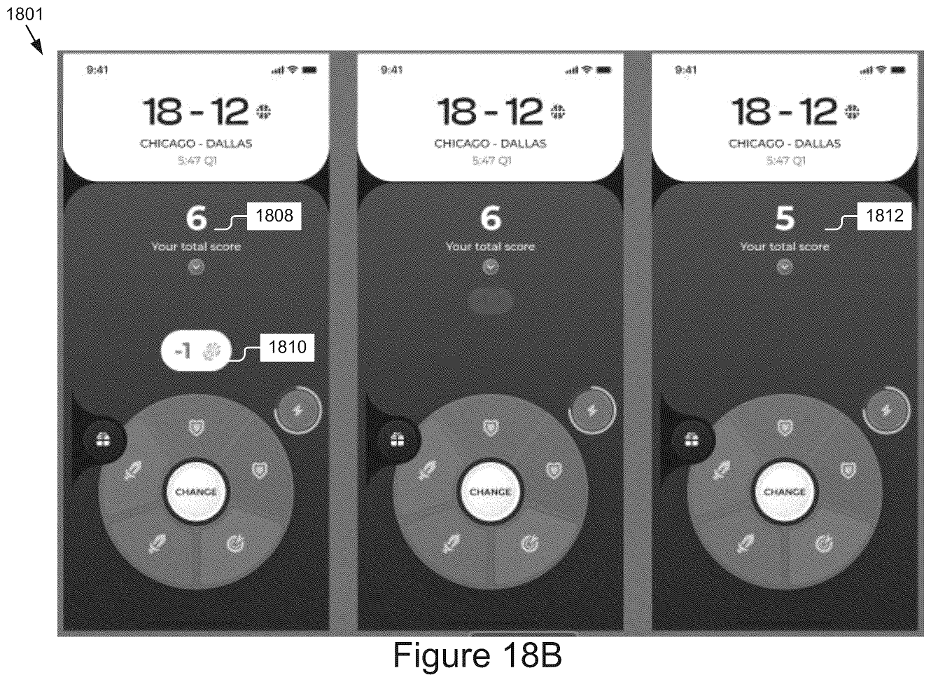

FIG. 18A depicts an example GUI 1800 of a score increase based on selecting clustered real-time event data. As shown in FIG. 18A, a user 110 can select various stategories and have a current score 1802 of “4”. A measurable statistic can occur on the live-event that reflects a statistic that is part of a stategory the user 110 has selected resulting in a point increase 1804 of “2” points. One or more various animations may occur to show the point increase 1804 such as a GUI pop-up and then it floats or moves into the total score 1802, etc. The total score 1806 may then be updated to reflect the change in the score based on the occurrence of the statistic in the real-time event and the selection of that statistic in the stategory selection.

FIG. 18B depicts an example GUI 1801 of a score decrease based on selecting clustered real-time event data. As shown in FIG. 18B, a user 110 can select various stategories and have a current score 1808 of “6”. A measurable statistic can occur on the live-event that reflects a statistic that is part of a stategory the user 110 has selected resulting in a point decrease 1810 of “1” point. One or more various animations may occur to show the point decrease 1810 such as a GUI pop-up and then it floats or moves into the total score 1812, etc. The total score 1812 may then be updated to reflect the change in the score based on the occurrence of the statistic in the real-time event and the selection of that statistic in the stategory selection.

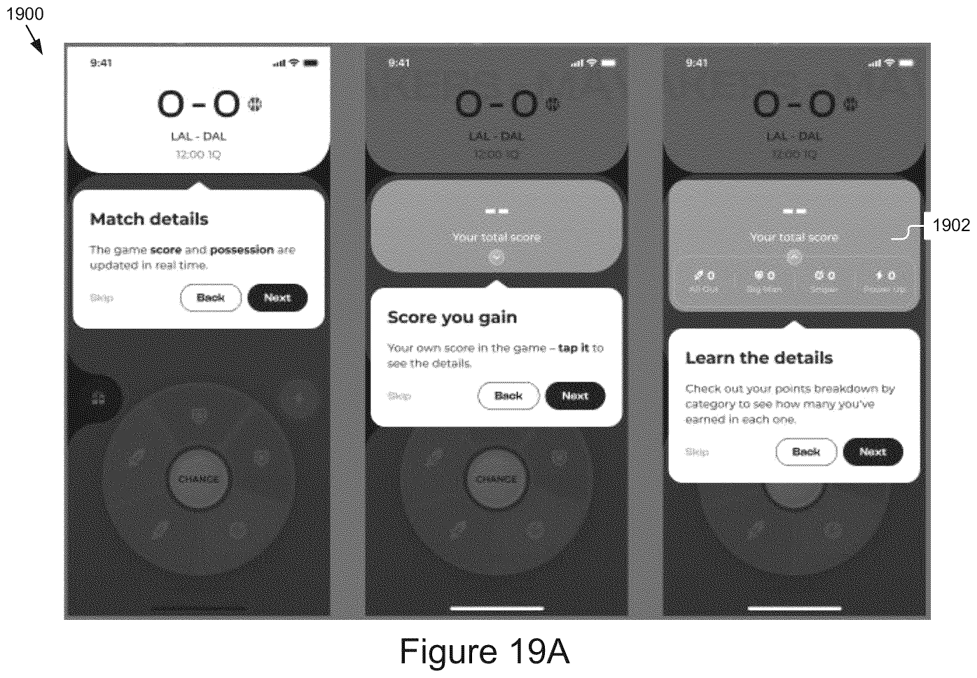

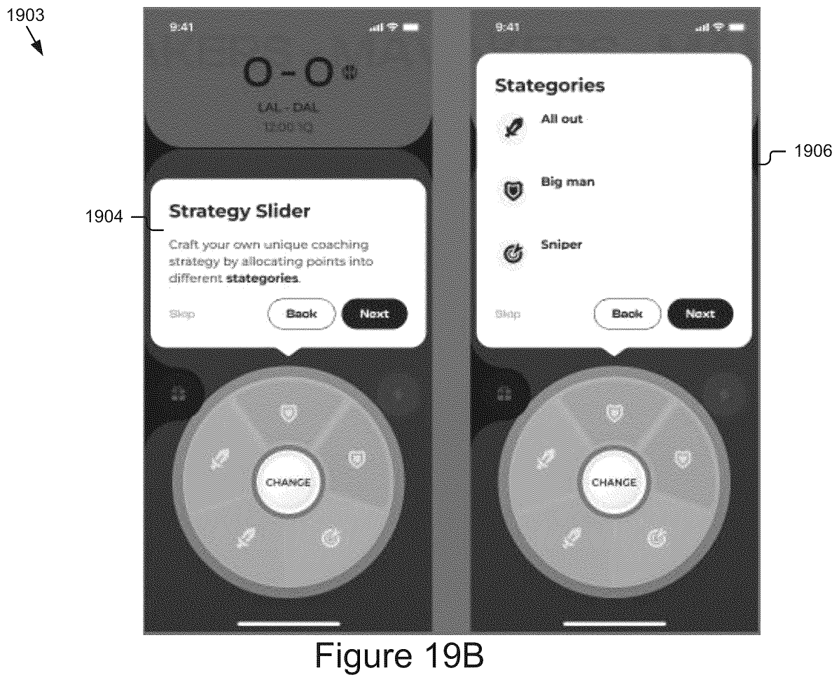

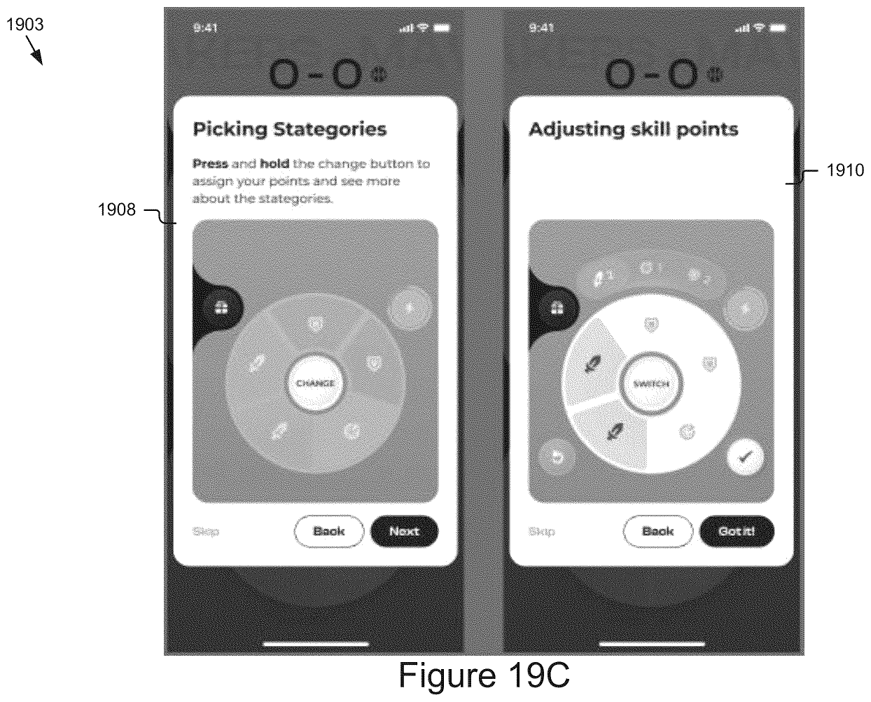

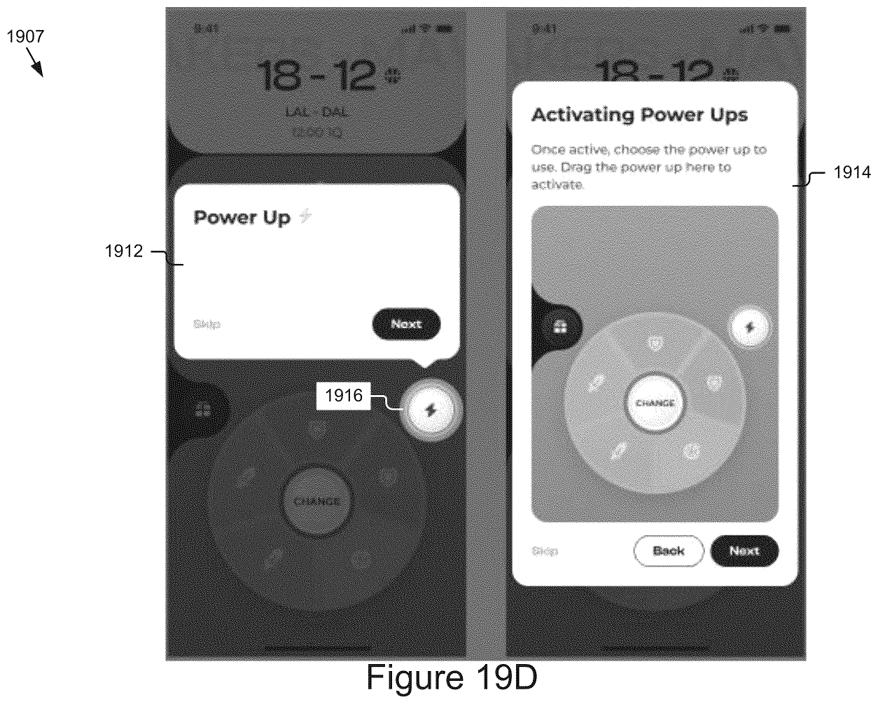

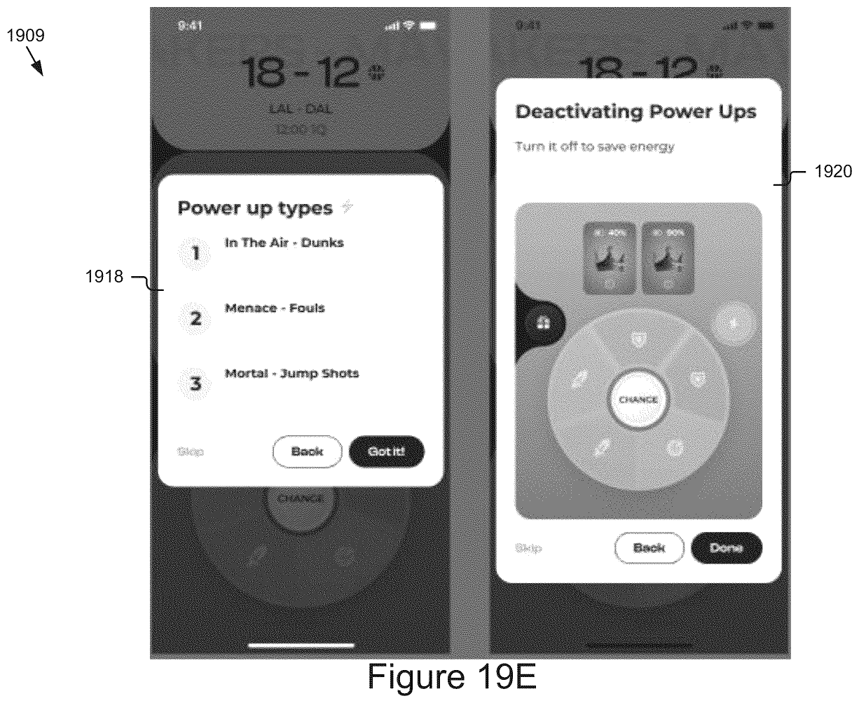

FIG. 19A depicts an example GUI 1900 of a tutorial screen for selecting clustered real-time event data. As shown, the tutorial screen may include one or more pop-ups explain how a user can score points in the application during the live-event. The total score as shown reflects the users 110 score based on an allocation of stategories. The total score breakdown 1902 can be viewed to see different score allocations based on the selected stategories that are being combined into the total score of the user 110.

FIG. 19B depicts an example GUI 1903 of an additional tutorial screen for selecting clustered real-time event data. As shown, a radial slider, also referred to as a “strategy slider” 1904 may be used in the application to allocate points in different stategories by the user 110. The user 110 can gain additional information about stategories 1906 as shown in the example tutorial screen. It should be understood that while three stategories allocated in five different tiles are shown in this example, any number of stategories and/or selections are contemplated to change the dynamic of the scoring for the application.

FIG. 19C depicts an example GUI 1905 of an additional tutorial screen for selecting clustered real-time event data. As shown in the example, the tutorial can explain how to select stategories 1908 by pressing and holding the change button to assign points or learn additional information about a stategory group. The points can then be adjusted by interacting with the radial slider 1910 to select different stategory groups as described elsewhere herein.

FIG. 19D depicts an example GUI 1907 of a tutorial screen for selecting clustered real-time event data and power-ups. As shown in the example, the tutorial can explain how to select a power-up bey interacting with the power-up selector 1916. The power-up selector 1916 may provide access to various power-ups a user 110 can select to alter their score in the application. The tutorial can explain how to activate power-ups 1914 to guide a user 110 in the use of the power-ups.

FIG. 19E depicts an example GUI 1909 of a tutorial screen for selecting clustered real-time event data and power-ups. As shown in the example, the tutorial can explain different types of power-ups available to a user, such as a power-up based on dunks, fouls, or jump shots, etc. These power-ups may multiple or change scores for a period of time based on the power-up and various bonuses for all different types of live-events are contemplated. In some implementations, power-ups use an in-game energy and can be deactivated 1920 to save energy during the live-event.

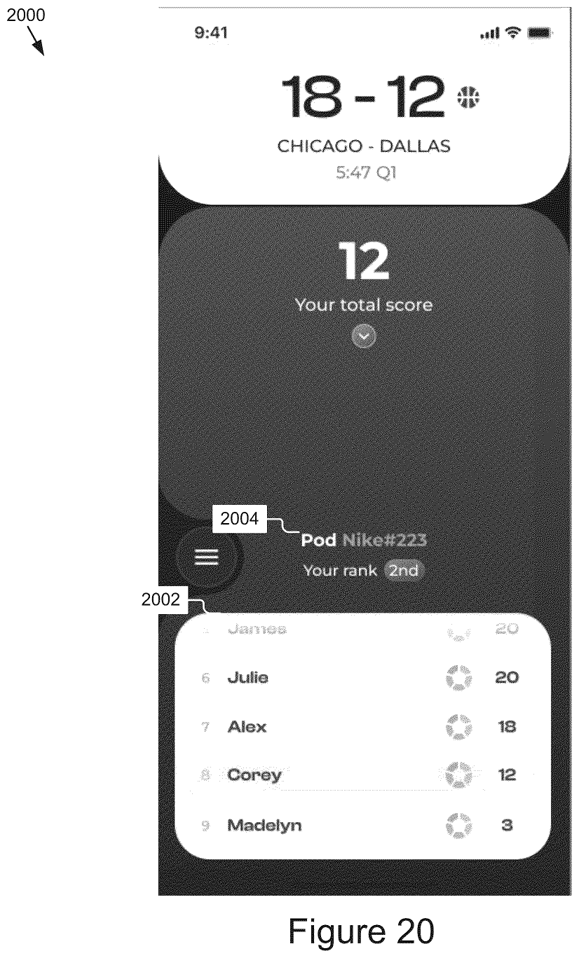

FIG. 20 depicts an example GUI 2000 of a pod of users and rankings within the pod of users. In some implementations, a user 110 may compete against a group of other users 110n, also referred to as a pod and a winner is determined from the pod 2002 based on the scores of the users 110. Pods may have different unique identifiers 2004 for engagement with other pods or application users at a larger level.

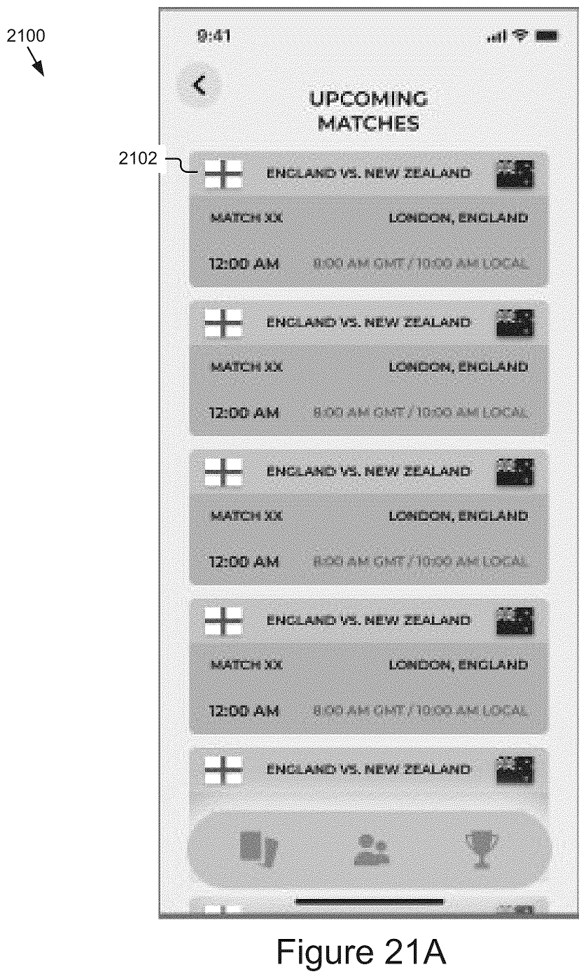

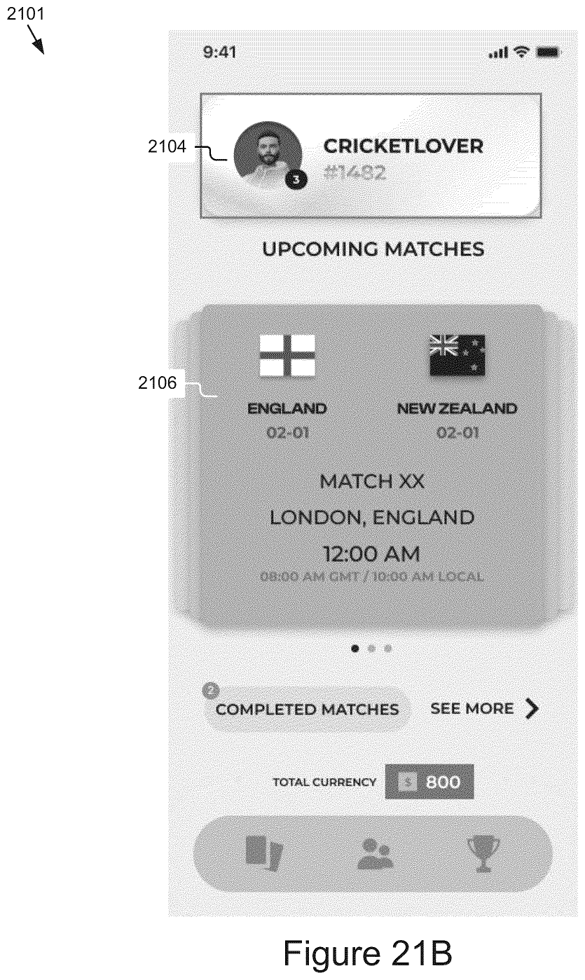

FIG. 21A depicts an example GUI 2100 depicting upcoming matches that can be used for selecting clustered real-time event data. As shown in the example, one or more cricket matches 2102 can be presented for a user 110 to select and then interact with during the selection of stategories. In this example, the stategories are based on a cricket match and measurable statistics from a cricket match, but other types of live-events are also contemplated.

FIG. 21B depicts an example GUI 2101 depicting addition details of an upcoming match that can be used for selecting clustered real-time event data. As shown, those additional details can include a user profile 2104 and or upcoming matches 2106 that a user has selected. In some implementations, a user 110 can also view previous matches and/or score breakdowns to observe which stategories provided points and inform decisions for future matches.

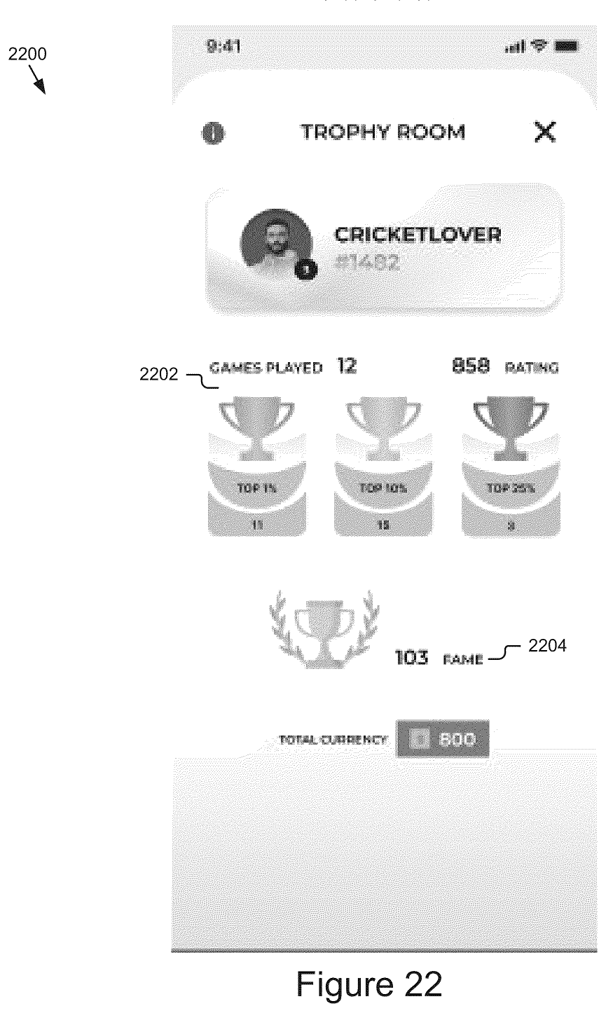

FIG. 22 depicts an example GUI 2200 depicting a user profile and trophy room associated with the user profile. As shown in the example, a user 110 can have a screen depeting various achievements 2202, such as showing how many games have been played and performance results from those games. Additionally, in some implementations, a user may have a fame rating 2204 that shows how the user 110 has compared to other users 110n.

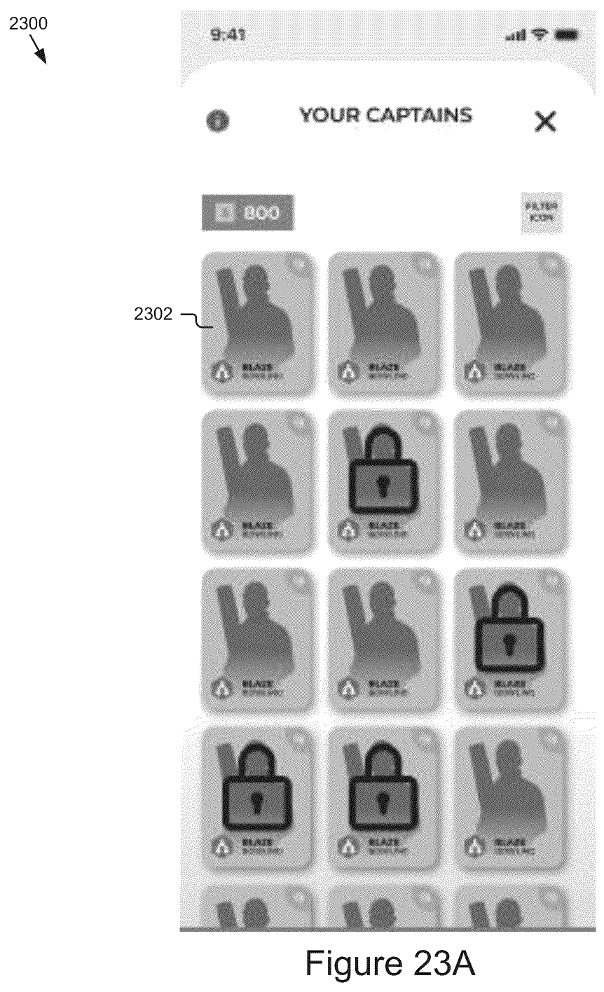

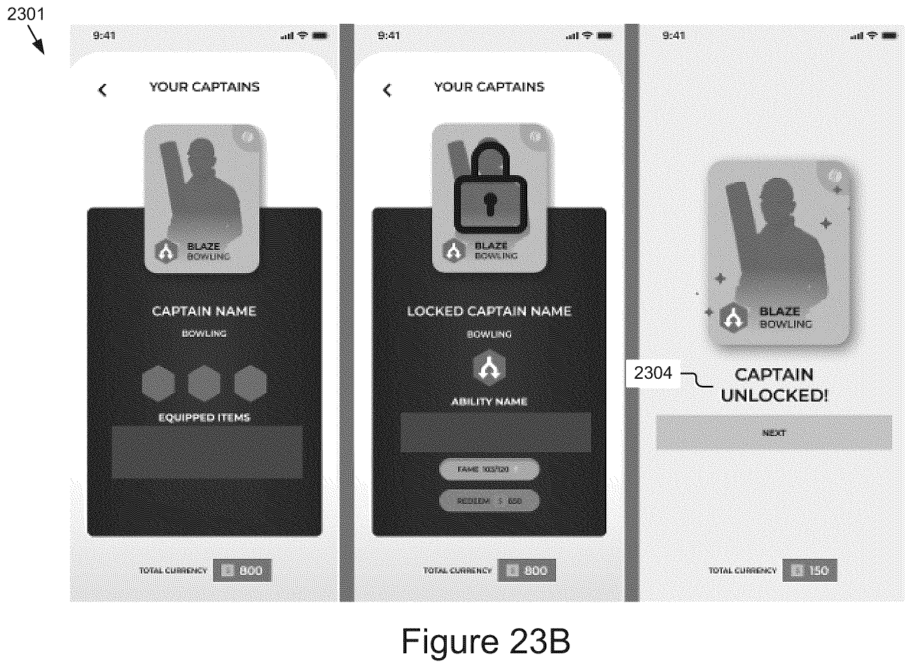

FIG. 23A depicts an example GUI 2300 depicting selectable captains that can be used during a selection of clustered real-time event data in an application. As shown, various captains 2302, that in some instances may be a way to allocating various stategories and/or power-ups are available to select by a user 110. Additionally, as shown in FIG. 23B, a user can unlock additional features and or captain options 2304. These captains act as a selection option to adjust various scores from stategories during the cricket match and user's 110 can gain different benefits and/or strategies based on the selected captain.

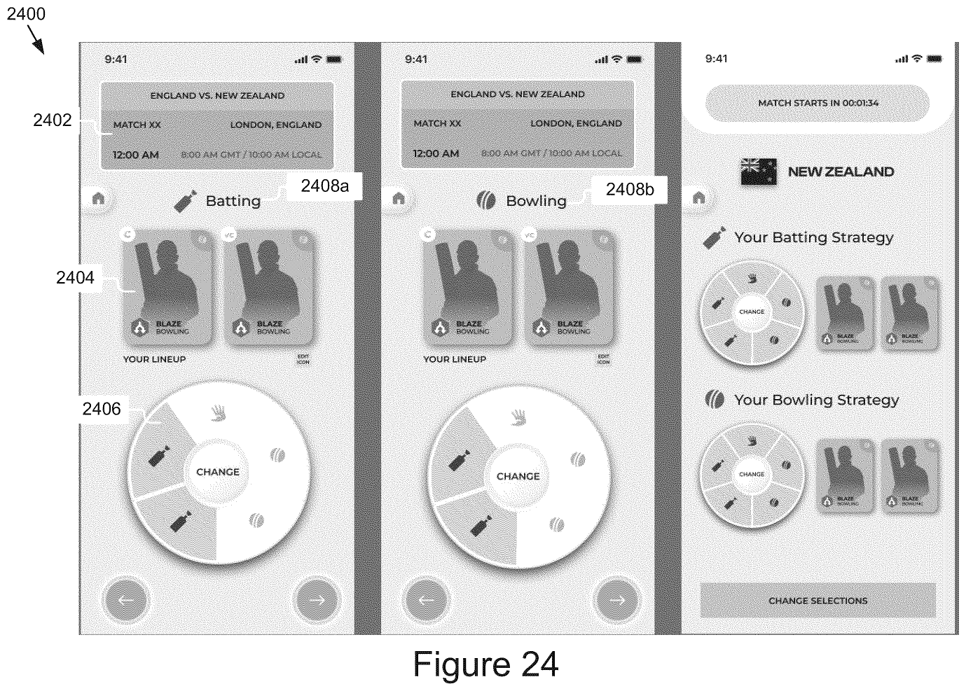

FIG. 24 depicts an example GUI 2400 depicting an example match in an application that can be used to select clustered real-time event data. As shown, various match details 2402 may be presented about the live-event, depicted as a cricket match in this example. A user 110 can view the selected captains 2404 for the match from their selected lineup. Additionally, the user 110 can select various stategories 2406 to adjust the score during the match. In some events, such as cricket, baseball, etc. there are different scoring dynamics based on what one team is doing. For example, in cricket, there is a batting portion 2408a and a bowling portion 2408b. A user 110 in this implementation can select different stategories for each of those portions to capture points from the different scoring dynamics. It should be understood that in some instances stategories can be separate for different scoring dynamics and any number of stategories can be used for different live-events.

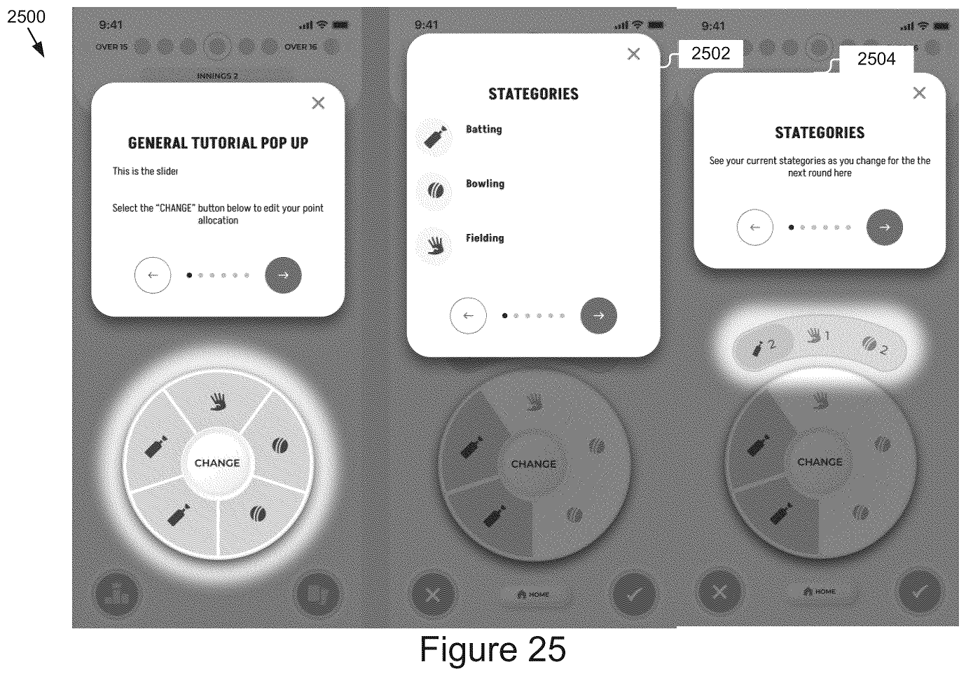

FIG. 25 depicts an example GUI 2500 of an additional tutorial screen for selecting clustered real-time event data. As shown in the example, a tutorial for a cricket match can be viewed to guide a user 110 in selecting various options. As shown, a user 110 can select from various stategories 2502 in cricket to cover different scoring dynamics, such as batting, bowling, or fielding. Additionally, those stategory allocations can be viewed and/or changed 2504 as desired by the user 110 during the live-event.

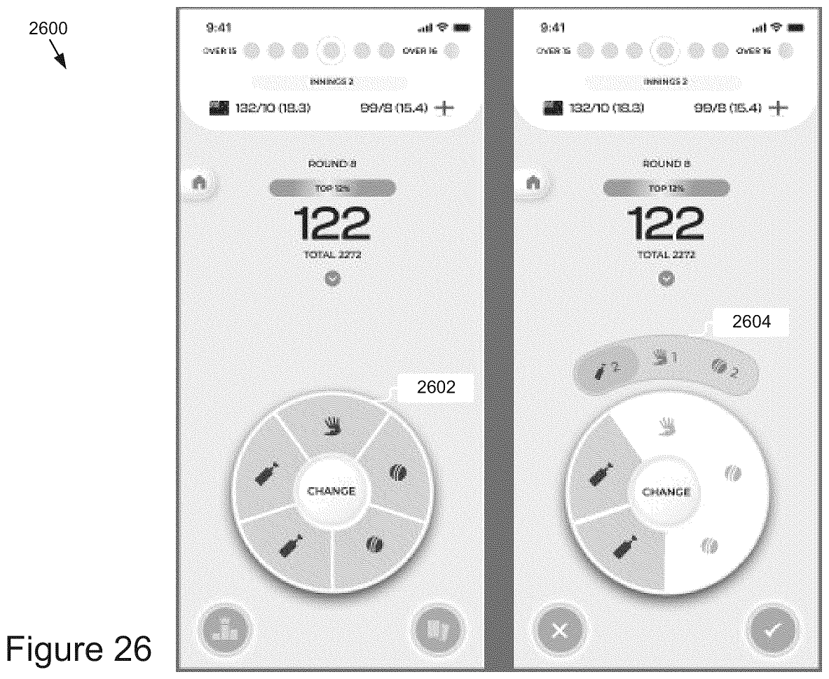

FIG. 26 depicts an example GUI 2600 of an application for selecting clustered real-time event data. As shown in FIG. 26, a user 110 can select various stategories 2602 and various different quantities of the stategories 2602, such as on the radial slider. The user 110 can also view the stategory allocation 2604 to view which stategories have been selected.

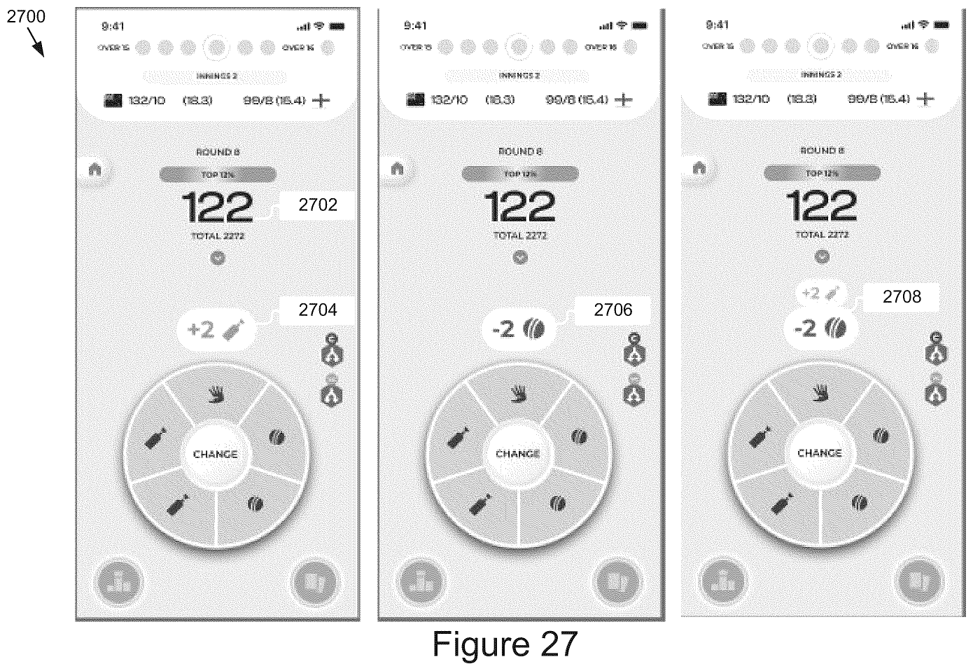

FIG. 27 depicts an example GUI 2700 of an application for adjusting a score based on selecting clustered real-time event data. As shown in the example, a user 110 may be able to view a current score 2702 based on their stategory selections. A statistic may be measured during the event and based on the user's 110 stategory allocations, the user 110 may score points as shown by the point increase 2704 depicting a score increase of “2”. Another statistic may be measured during the live-event depicting a point decrease 2706 in the total score of “2”. As shown, the animation of the score increases and decrease 2708 may help the user 110 to view the score change, which in this case is zero as the score increase and the score decrease cancel each other out.

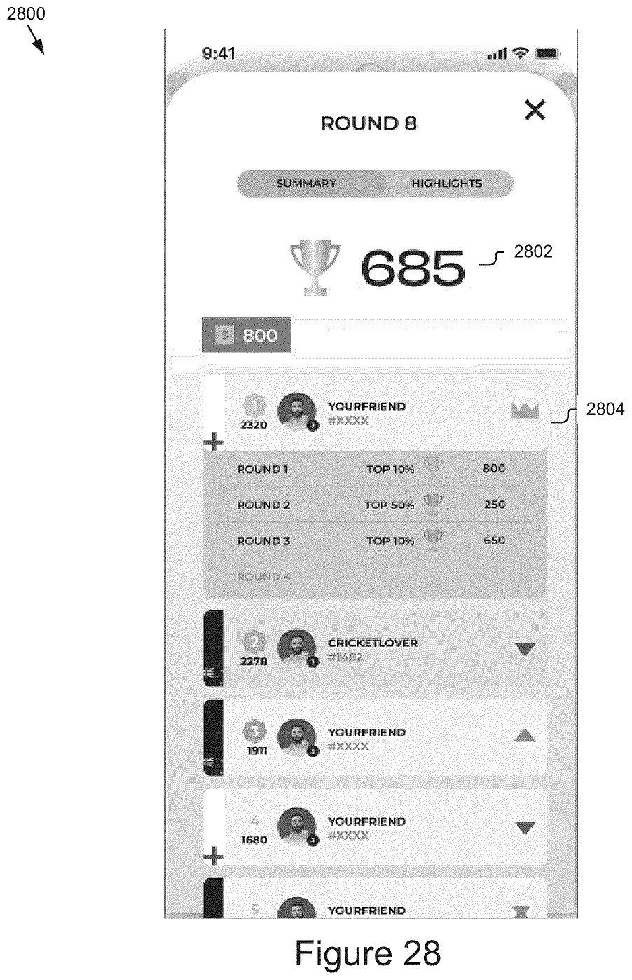

FIG. 28 depicts an example GUI 2800 of a group of users and rankings within the group of users. As shown, at the end of the match, a score 2802 may be presented showing the users 110 score compared to other users 110n. In some implementations, the score may include performances during the different rounds 2804 and/or a comparison of rankings with other users 110n.

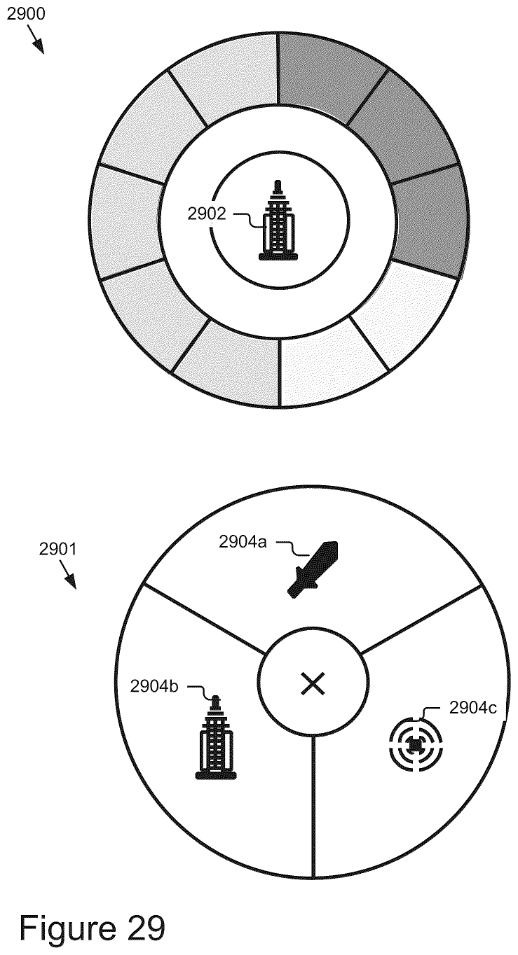

FIG. 29 depicts an example GUI 2900 and example GUI 2901 showing a selection of clustered real-time event data. AS shown in the GUI 2900, a user can select a stategory representing a grouping of clustered real-time event data. As shown in GUI 2900, the stategory may be a “Big Man” stategory represented by a building icon and awarding points for actions taken by a center or forward during a basketball game in this example. A user 110 can select the central button 2902 depicting the icon of the building to launch the stategory selection menu shown in GUI 2901. The stategory selection menu can display different selectable elements 2904a-2904c with icons or words that represent different stategories that the user 110 can switch to. In some implementations, a user can release the central button to exit the stategory selection menu or instead slide their touch input from the center to one of the selectable elements 2904 on the stategory selection menu to change to a different stategory.

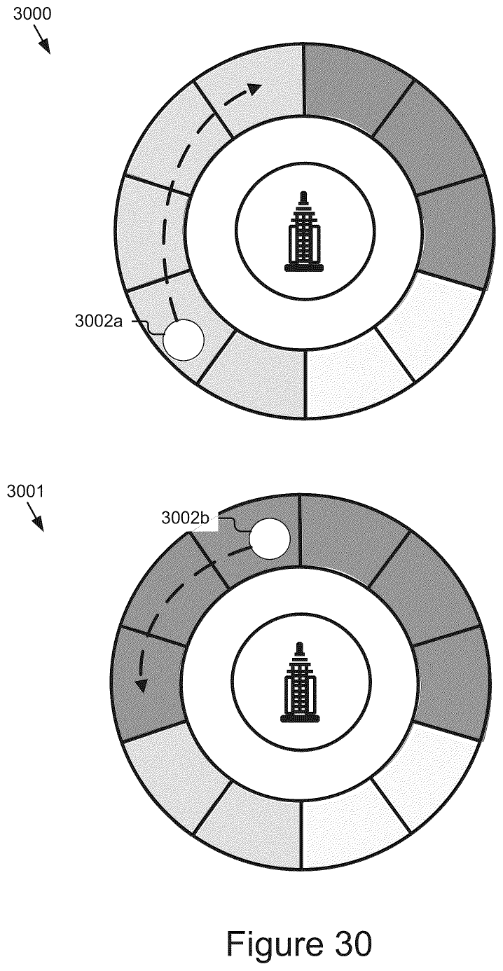

FIG. 30 depicts an example GUI 3000 and example GUI 30001 showing a selection of clustered real-time event data on a radial slider. As shown in GUI 3000, a user 110 can provide an input as a swipe in a radial motion in either direction. In a first example in GUI 3000, the user 110 initiates a swipe at the input point 3002a and traces around the radial slider in a clockwise motion to a stopping point and the selection application 108 can determine how many selectable elements were contacted during the clockwise motion. In another example in GUI 3001, the user 110 initiates a swipe at the input point 3002b and traces around the radial slider in a counter-clockwise motion to a stopping point and the selection application 108 can determine how many selectable elements were contacted during the counter-clockwise motion. This allows the radial slider to gather inputs from a user regardless of a direction of the swipe when breaking the selectable element plane. In the examples in GUI 3000 and GUI 3001, the selectable elements are marked by different colored shading to show different stategory selections. If a selectable element was not marked, then as the input passes over the selectable element, then the selectable element becomes shaded or marked with a similar color as the input point selection. If a user 110 swipes in an opposite direction to the original swipe, then any selectable element that was marked during an edit is reversed to the original shading or marking to allow a user 110 to undo a selection as they interact with the radial slider. If a swipe is reversed, when the tile plane of the anchor selectable element where the input point 3002 was detected has been broken by the input than the swipe direction changes. The selection application 108 can detect and track the various touch inputs around the radial slider with selectable elements represented as different tiles and update the changes made based on the inputs. This allows for omni-directional swipes around the radial slider and easy adjustments when a swipe is reversed.

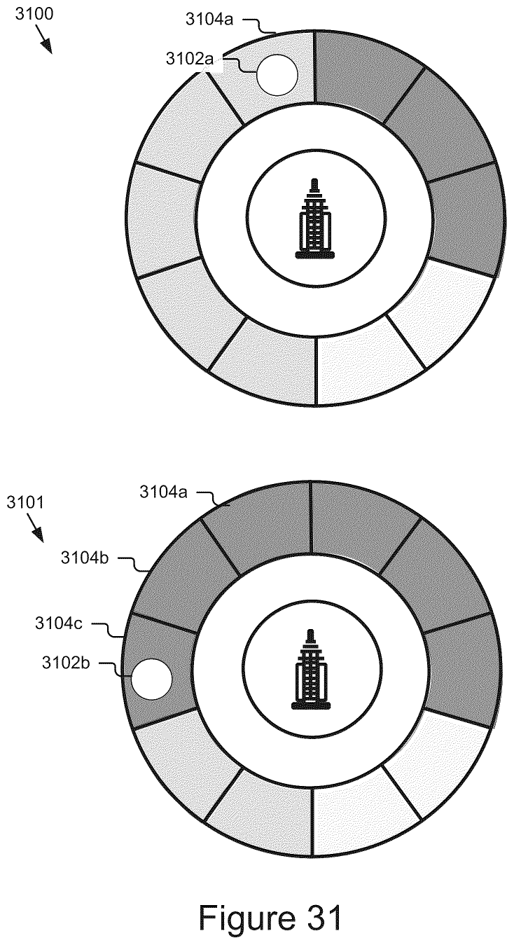

FIG. 31 depicts an example GUI 3100 and example GUI 3101 showing a selection of clustered real-time event data on a radial slider. As shown in the example in GUI 3100, a user 110 can make a selection such as at the input point 3102a on input tile 3104a. The user 110 may then select additional tiles shown in GUI 3101 as the input point 3104b ends on input tile 3104c. The selection application 108 may then detect a release of the input point 3104b at input tile 3104c and convert all of the selected input tiles 3104b-3104c from a light gray shading to a darker gray shading to indicate a change in a stategory selection.

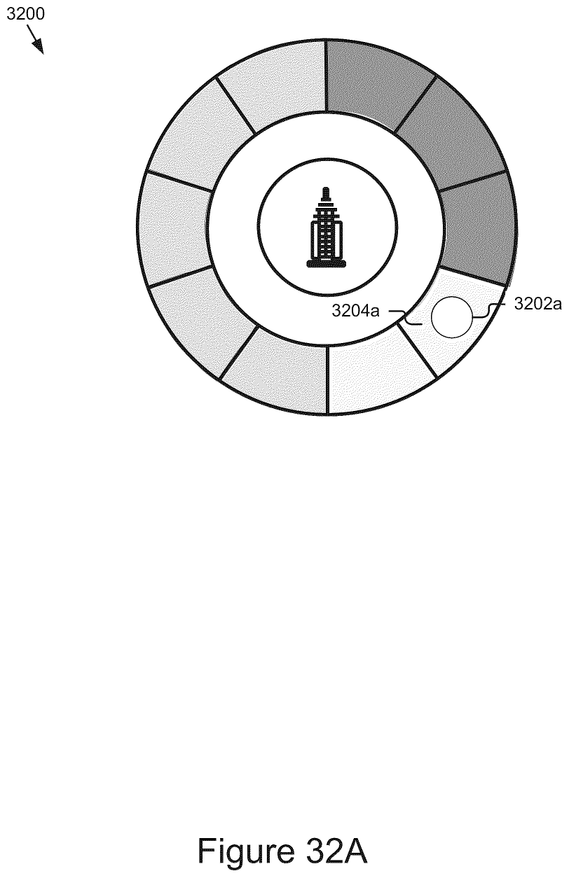

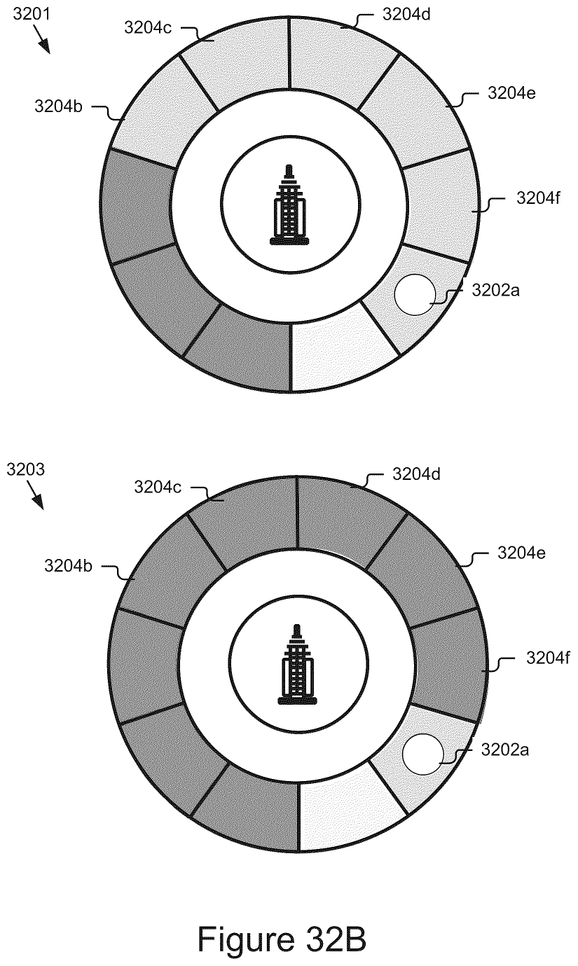

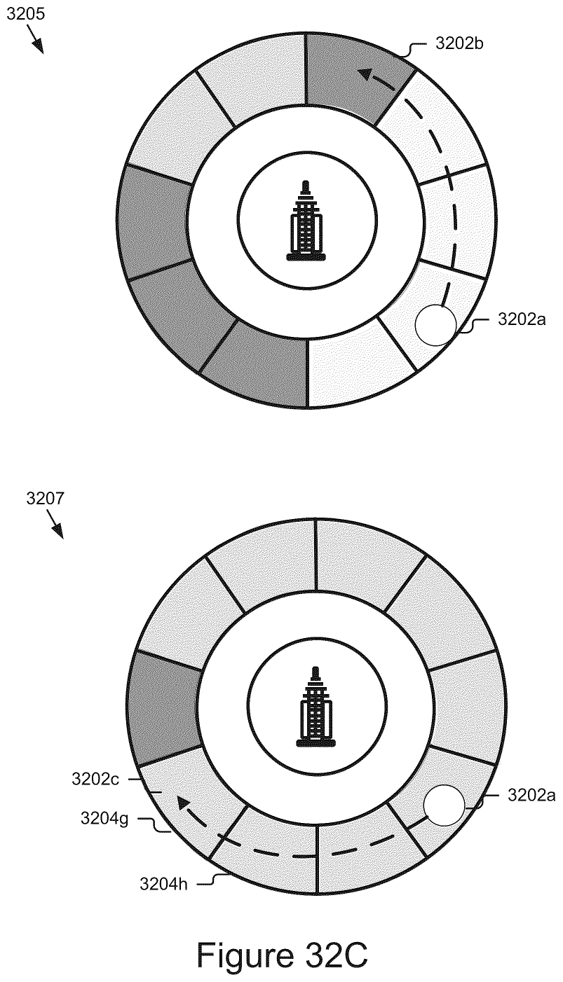

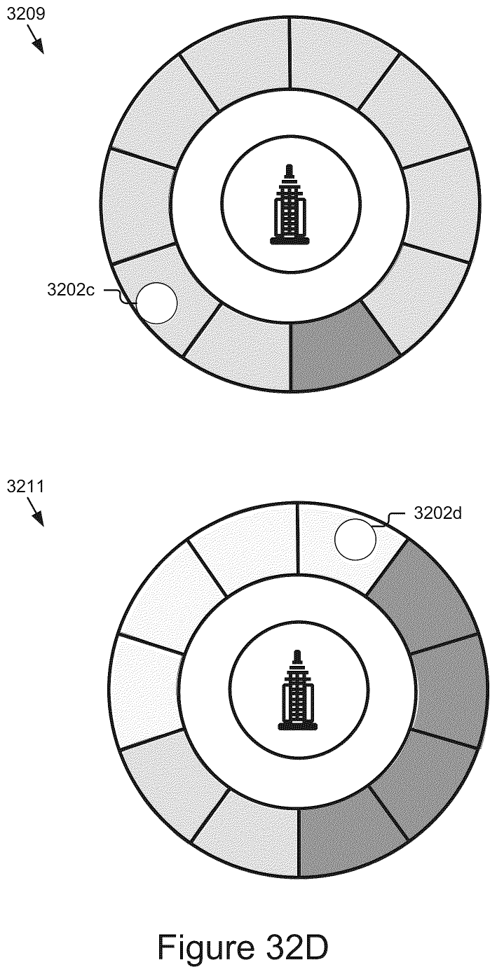

FIG. 32A depicts an example GUI 3200 showing a selection at an input point 3200a of clustered real-time event data on a radial slider. The input point 3202a indicates a tapping of the selectable element 3204a and changing the selectable element 3204a to a chosen stategory based on the input. In some implementations, the selection application 108 may also convert the shading or coloring of the selectable element 3204a to reflect the change in the stategory.

FIG. 32B depicts an example GUI 3201 and example GUI 3203 showing a selection of clustered real-time event data on a radial slider. As shown in the example, a tapped tile from GUI 3200 changes to a chosen stategory on the input point 3202a. In some implementations, an auto adjustment of other input tiles 3204b-3204f may also occur where as shown in GUI 3201, all of the other input tiles 3204b-3204f are a first background shading in GUI 3201 and all of the other input tiles 3204b-3204f are converted a second background shading in GUI 3203 to reflect an automatic adjustment in the stategory selection clockwise to the input point 3202a.

FIG. 32C depicts an example GUI 3205 and example GUI 3207 showing a selection of clustered real-time event data on a radial slider. As shown in GUI 3205, a user may select an input point 3202a and may rotate counter-clockwise to an end point 3202b which causes all tiles selected between the input point 3202a and the end point 3202b to convert to the selected stategory at the input point 3202a and update the shading as shown in GUI 3207. In GUI 3207, the user 110 may select the input point 3202a and may slide clockwise to the end point 3202c causing the selectable tiles 3204h and 3204g to be converted to the selected stategory and update their respective backgrounds to reflect that selection.

FIG. 32D depicts an example GUI 3209 and example GUI 3211 showing a selection of clustered real-time event data on a radial slider. As shown in GUI 3209, a tapped tile represented by input point 3202c can cause the tapped tile to change to a chosen stategory on tap and allows for auto sort of the tiles on release. As shown in GUI 3209, a tapped tile represented by input point 3202d can cause the tapped tile to change to a chosen stategory on tap and allows for auto sort of the tiles on release.

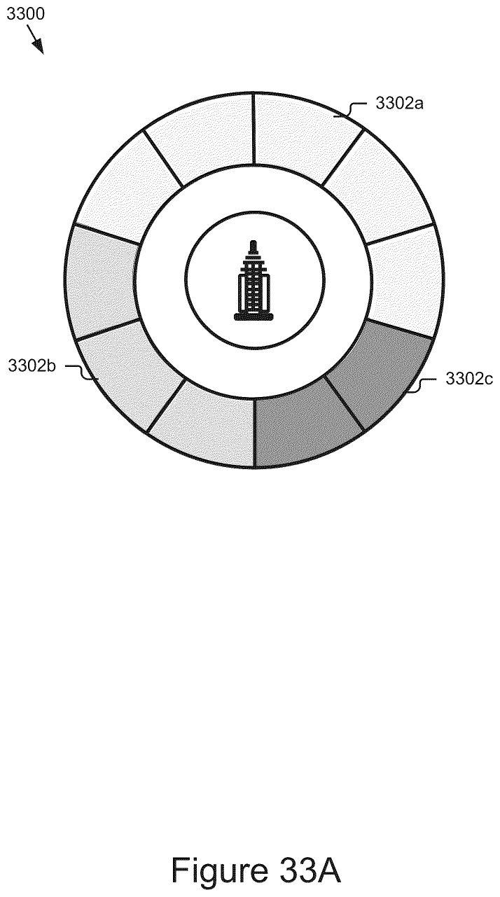

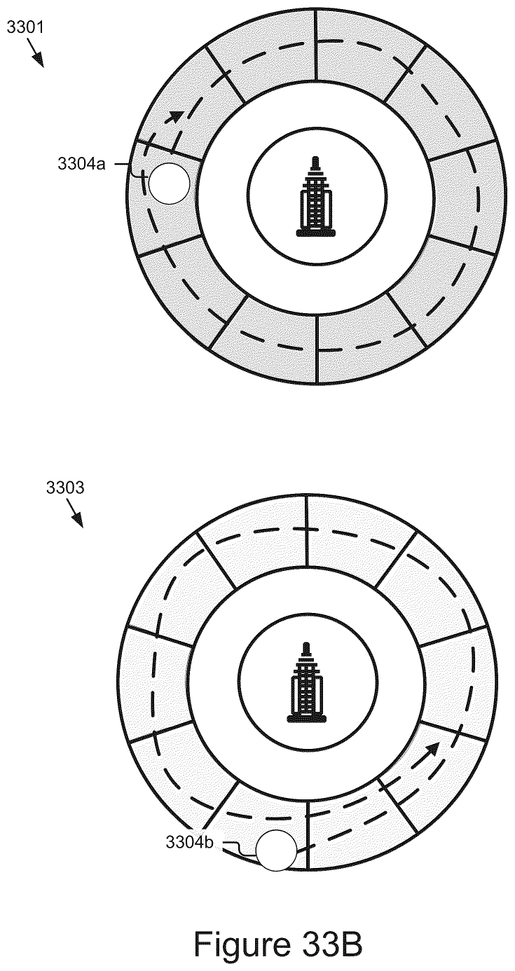

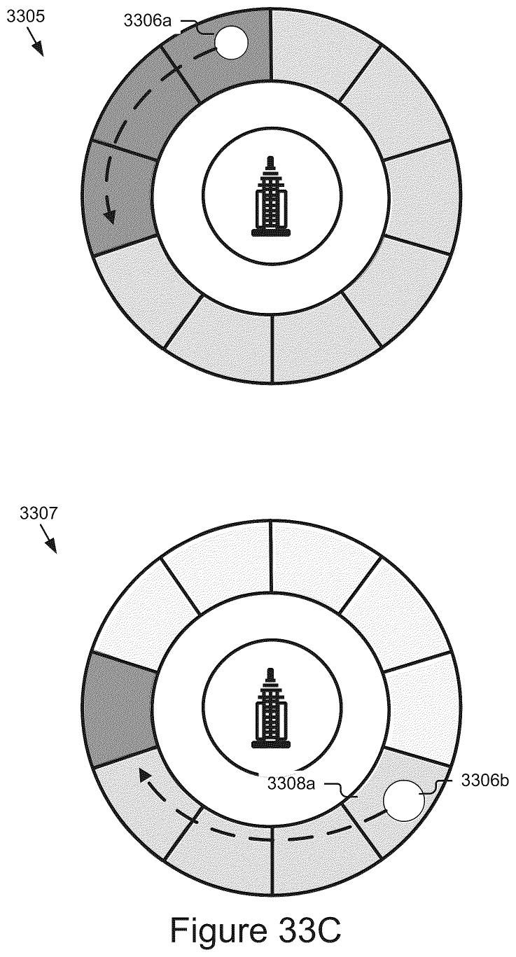

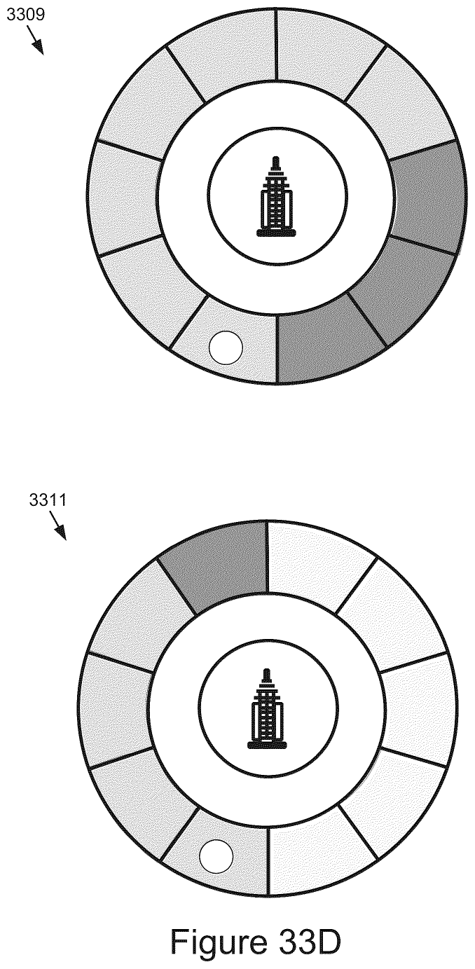

FIG. 33A depicts an example GUI 3300 showing a selection of clustered real-time event data on a radial slider. In this example in GUI 3300, an example starting state is depicted showing a selection of a stategory on the middle circle and three different stategories groups already selected as depicted by the three different group shading 3302a-3302c of selectable tiles.

As shown in FIG. 33B, in GUI 3301 a user can select an input selection 3304a or in GUI 3303 at input selection 3304b and then if a 360 degree swipe around the radial slider is done then all of the selectable tiles will change to the selected stategory and the backgrounds of the selectable tiles can be updated to the selected stategory. If a swipe exceeds the 360 degrees either clockwise as shown in GUI 3301 or counter-clockwise as shown in GUI 3303 the input point will move from the start of the swipe to the current end of the swipe position. Once all of the selectable tiles in the 360 degree swipe have been selected and it is overfilling, the overfilled selections are ignored as long as the swipe continues in a same direction.

FIG. 33C depicts an example GUI 3305 and example GUI 3307 showing a selection of clustered real-time event data on a radial slider. In the examples in GUI 3305 and GUI 3307, if a user performs a 360 degree swipe around the radial slider and then changes direction, the selection application 108 can treat the change of the direction of the swipe as the origin of the swipe to determine stategory changes. For example, if in GUI 3305, a full 360 degree swipe is done from the input point 3306a and the swipe continues to the selectable tile 3308a shown in GUI 3307, then if the user changes directions of the swipe at selectable tile 3308a, then as shown in GUI 3307, the change at selectable tile 3308a is treated as the input point 3306b and selections based on the stategory represented by selectable tile 3308a are made in the clockwise direction until the user ends the swipe in the clockwise direction.

FIG. 33D depicts an example GUI 3309 and example GUI 3311 showing a selection of clustered real-time event data on a radial slider. As shown in GUI 3309 and in GUI 3311, when a user selects various inputs and changes those stategories at the selected tiles, the selection application 108 may auto sort the selection to group the stategories together after the user selects them.

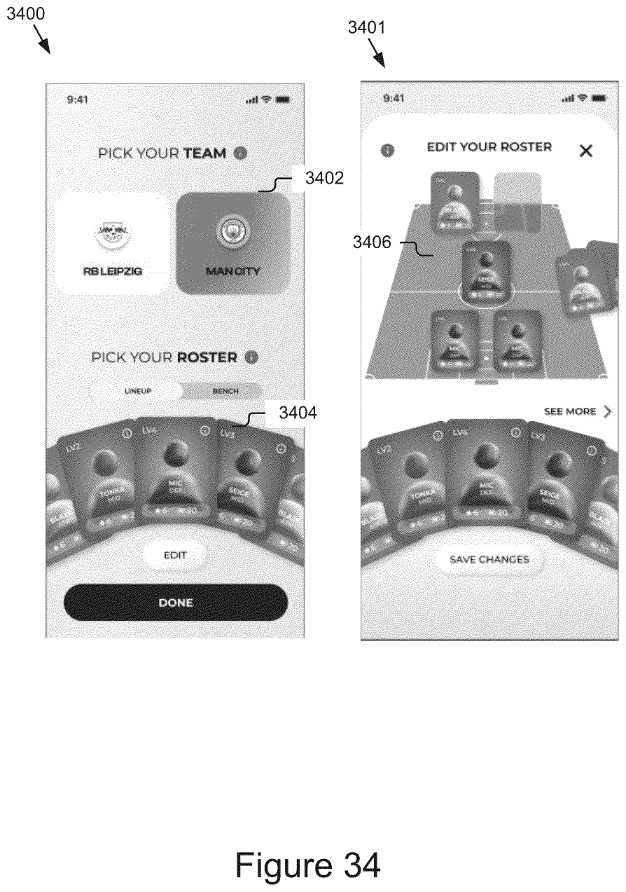

FIG. 34 depicts example GUIs 3400 and 3401 showing a selection of clustered real-time event data. As shown in FIG. 34, a user 110 can be presented with a match selection 3402 for a football/soccer match. As shown in GUI 3400, a user 110 can select a roster 3404 of players that can be deployed in a deployment area 3406 similar to how the radial slider works in other implementations. A user 110 can select a roster of different characters that have different traits. In some implementations, the roster selections are characters based on real players with traits that mirror the real players traits. In other implementations, the charactes are fictional and have various types of traits that impact how the game is played while the real-life soccer match is occurring. As shown in GUI 3401, the deployment area may look like a soccer field with deployment subsections for attackers, midfielders, defenders, and/or goalies. In some implementations, a user 110 is playing against a computer or environment player that may deploy various strategies against the user 110 to counter the decisions and/or changes a user 110 makes when deploying their roster into the deployment zones. In further implementations, the user 110 may be playing against another user 110n in a head to head situation where each user 110 is deploying their roster into the deployment zones to counter each other. In some implementations, multiple different users 110 may all be competing against each other and the actions of one user 110 can impact the others 110 as they play.

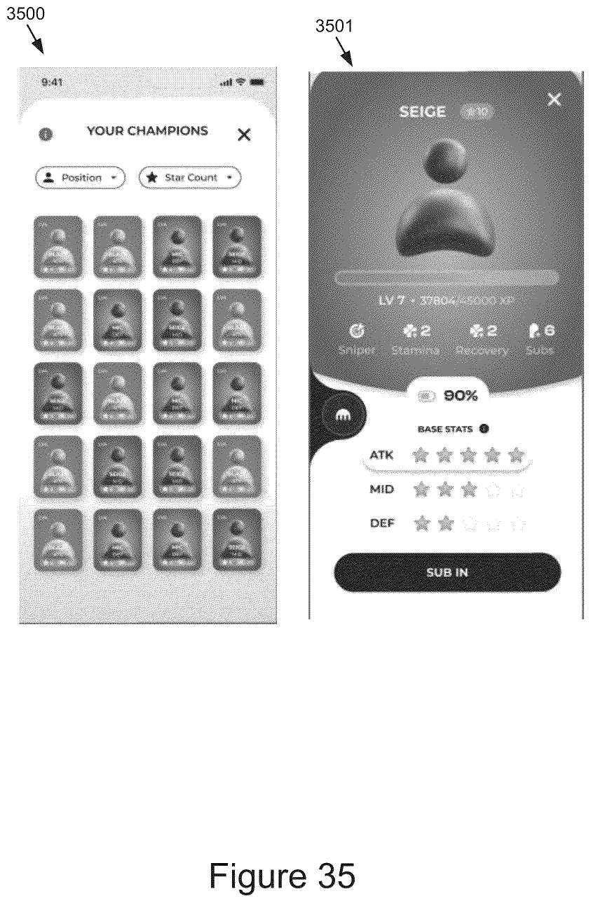

FIG. 35 depicts example GUIs 3500 and 3501 showing selections of stategories for an application. As shown in GUI 3500, a roster may be a selection of cards or characters that the user can select to deploy in order to make a selection of various stategories. In some implementations, each of the characters in the roster has different traits based on what kind of measured statistics are occurring in the real-live event as well as based on where the character is placed. For example, an attacker character placed in the attacker deployment may have functionality to multiply points every time a shot on goal is attempted in that correlating portion of the field, etc. As shown in GUI 3501, each character may have one or more strength/weaknesses based on their traits, such as a level of stamina, a level of recovery, a substitution level, a sniper level, etc. The user may deploy the character from the roster into the deployment area and then the selection application 108 may provide those selections to the activity application 126 for calculating point scores based on the traits of the character. Additionally, as a character is deployed in the deployment zone, in some implementations, a stamina or other trait may decrease such that the character would need to be replaced from the roster eventually during the application. This provides an additional strategy similar to real-life coaching where the user 110 has to decide when to substitute characters from the roster, etc. In some implementations, a roster may be stored in a digital vault until the character is used. In other implementations, the roster is where the characters are ready for use in the deployment zone, whether a pitch, court, field, etc. In some implementations, when a character is used in one roster, the character can not be used simultaneously in another roster. For example, if a user 110 is playing two games concurrently, if the user 110 deploys a specific character in one game, that character is not also available in another game. This allows for some skill based matchmaking, where users 110 can have good rosters in one game and various other types roster in another game concurring simultaneously. This allows users 110 to manage their time and still make user of less valuable characters in lower rounds based on skill and/or card type.

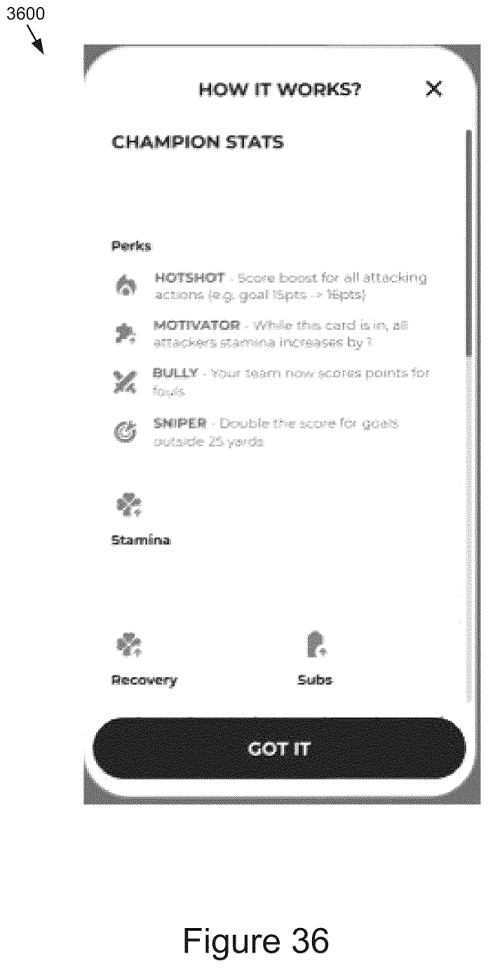

FIG. 36 depicts example GUIs showing example selections of stategories for an application. As shown in GUI 3600, the champions may have one or more perks or traits that alter the effect of the score based on the perks or traits. When a measured statistic is detected in real-life that correlates to a perk or trait from the champion, then the activity application 126 may effect the score based on how the perk or trait changes the score, etc.

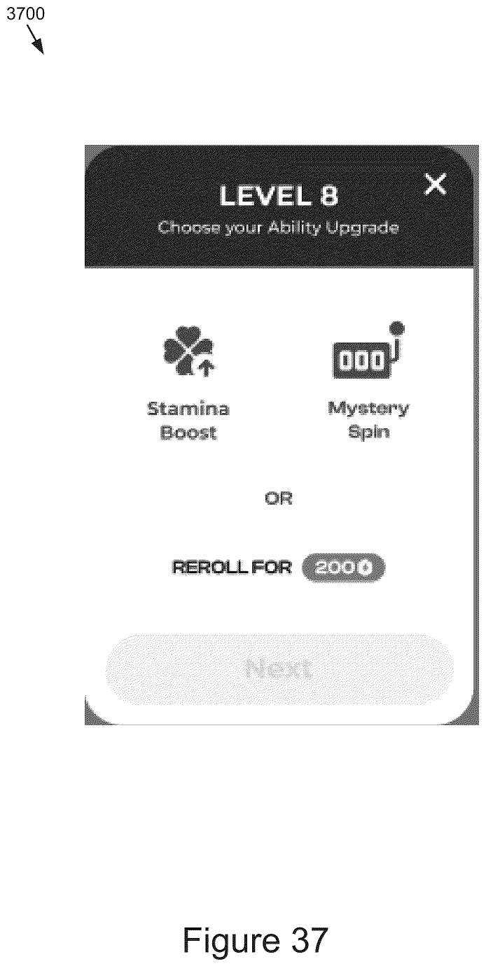

FIG. 37 depicts an example GUI showing an upgrade of a stategory trait. As shown in GUI 3700, when characters from a roster have progressed enough, such as buy being used for a period of time, winning a match, or purchasing tokens/money to pay to upgrade the champion. When the champion is upgraded, as shown in GUI 3700, the traits or perks of the champion can be improved, sometimes based on a user selection and other times based on a random generation of an upgrade to a perk and/or trait.

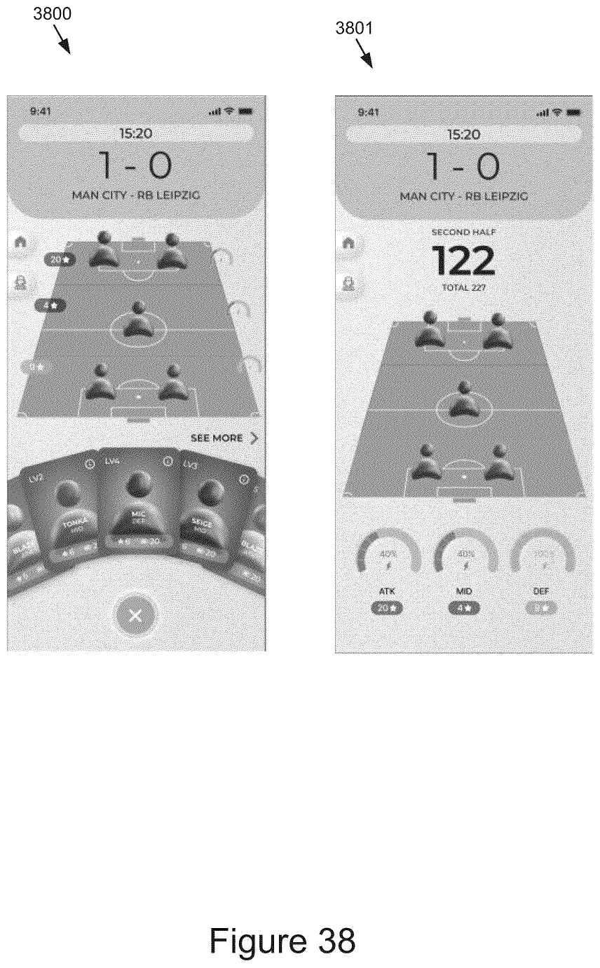

FIG. 38 depicts example GUIs showing a selection of clustered real-time event data. As shown in GUI 3800, the deployment area may include options for where to place various champions or other characters. This deployment area acts similar to the radial slider or other types of stategory selections, but instead of manually selecting specific stategories from the slider, a user places a character from the roster that already has some specified stategories applied to the character. The deployment area provides another mechanism for a user to make a selection that mimics the actions of a coach preparing for a match to provide additional options for selecting stategories to score points.

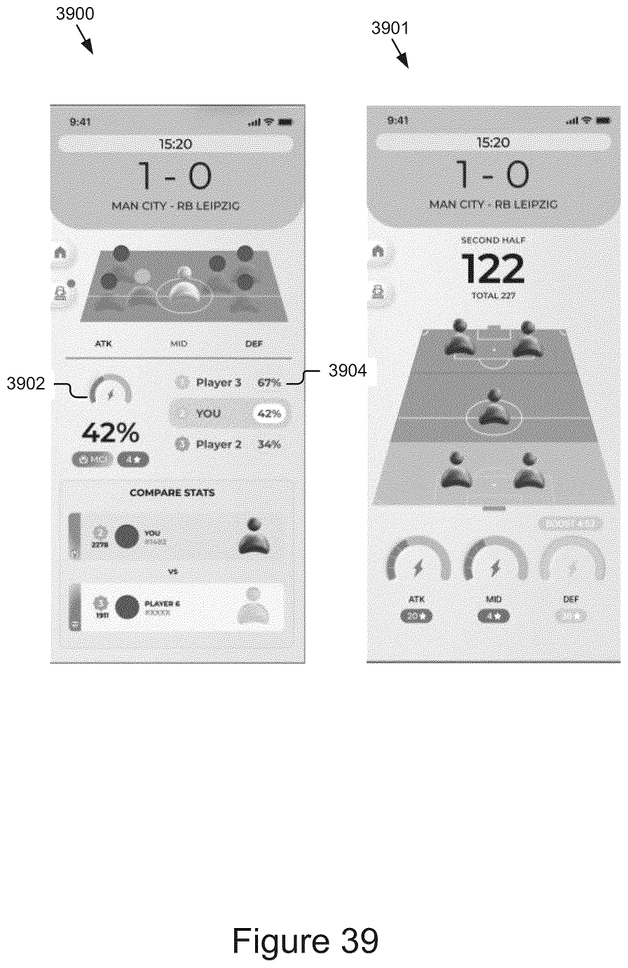

FIG. 39 depicts example GUIs showing a selection of clustered real-time event data. As shown in GUI 3900, in some implementations, each of the subsections or zones of the deployment area may have a momentum meter 3904 attached to it as shown in GUI 3900. The moment meter 3904 may present to the user 110 how much the user 110 has dominated the zone and when the users 110 momentum exceeds a threshold (such as 100%) an additional bonus, such as a 4× multiplier, etc. is activated and the user gains additional scores. As shown at 3906, the user 110 may see the zone become highlighted when it is dominated and the user is scoring bonuses for dominating the zone.

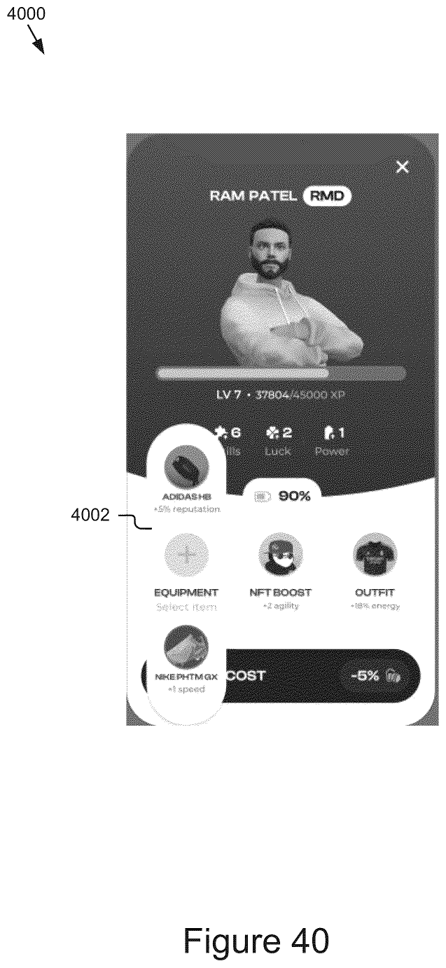

FIG. 40 depicts an example GUI 4000 depicting a champion with various 4002 branded assets that can be linked into the application to improve a champion/roster character with branded assets a user can acquire 110 in real-life or digitally that can apply an additional bonus to the champion that increase points earned based on stategory selections. As shown, various stats of a champion, character, roster, or other stategory feature may be changed based on the item held by the character and/or associated with the power-up. Various real-world brand relationships can be used to provide monetization options within the application while also not inundating a user 110 with direct advertisements. In some implementations, there can be multiple levels of game mechanics, such as a simple version for beginning users and more advanced levels such as pro versions for more invested users, or a paid version, etc.

In some implementations, the clustered real-time event data could be used in other implementations besides to score points in an application while viewing a live event. For example, the clustered real-time event data could be used in risk management implementations where the data can be used in sports betting operations when calculating the expected value correctly and defining risk tolerance is where the house gets its advantage over the user. Using the weighted clusters of real-time event data by calculating dynamic weights to clustered data is a novel approach to set up market indices and advanced big data analysis in very low latency.

In another implementation, the clustered real-time event data could be used for live performance analysis where specific statistics could be grouped in unique ways with dynamic weights to adjust the real-time decision making. For example, as a pro-athlete, you could analyze the data and use that data to make smarter real-time decisions. Additionally, using this data could be useful in media applications for entertainment, educational, or other purposes. Such as to react to the market and identify trends based on uniquely weighted clusters or real-time data that can be used to respond to changes in substantially real-time. In another implementation, this clustered real-time event data could be used in businesses intelligence and/or interactive advertising where clustered real-time events can be processed in near zero time to generate business logic or to fire smart triggers based on ephemeral user sentiment and intents.

In the above description, for purposes of explanation, numerous specific details are set forth in order to provide a thorough understanding of the present disclosure. However, it should be understood that the technology described herein can be practiced without these specific details. Further, various systems, devices, and structures are shown in block diagram form in order to avoid obscuring the description. For instance, various implementations are described as having particular hardware, software, and user interfaces. However, the present disclosure applies to any type of computing device that can receive data and commands, and to any peripheral devices providing services.

In some instances, various implementations may be presented herein in terms of algorithms and symbolic representations of operations on data bits within a computer memory. An algorithm is here, and generally, conceived to be a self-consistent set of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

To ease description, some elements of the system 100 and/or the methods are referred to using the labels first, second, third, etc. These labels are intended to help to distinguish the elements but do not necessarily imply any particular order or ranking unless indicated otherwise.

It should be borne in mind, however, that all of these and similar terms are to be associated with the appropriate physical quantities and are merely convenient labels applied to these quantities. Unless specifically stated otherwise as apparent from the following discussion, it is appreciated that throughout this disclosure, discussions utilizing terms including “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Various implementations described herein may relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, including, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The technology described herein can take the form of an entirely hardware implementation, an entirely software implementation, or implementations containing both hardware and software elements. For instance, the technology may be implemented in software, which includes but is not limited to firmware, resident software, microcode, etc. Furthermore, the technology can take the form of a computer program product accessible from a computer-usable or computer-readable medium providing program code for use by or in connection with a computer or any instruction execution system. For the purposes of this description, a computer-usable or computer readable medium can be any non-transitory storage apparatus that can contain, store, communicate, propagate, or transport the program for use by or in connection with the instruction execution system, apparatus, or device.

A data processing system suitable for storing and/or executing program code may include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input or I/O devices (including but not limited to keyboards, displays, pointing devices, etc.) can be coupled to the system either directly or through intervening I/O controllers.

Network adapters may also be coupled to the system to enable the data processing system to become coupled to other data processing systems, storage devices, remote printers, etc., through intervening private and/or public networks. Wireless (e.g., Wi-Fi™) transceivers, Ethernet adapters, and Modems, are just a few examples of network adapters. The private and public networks may have any number of configurations and/or topologies. Data may be transmitted between these devices via the networks using a variety of different communication protocols including, for example, various Internet layer, transport layer, or application layer protocols. For example, data may be transmitted via the networks using transmission control protocol/Internet protocol (TCP/IP), user datagram protocol (UDP), transmission control protocol (TCP), hypertext transfer protocol (HTTP), secure hypertext transfer protocol (HTTPS), dynamic adaptive streaming over HTTP (DASH), real-time streaming protocol (RTSP), real-time transport protocol (RTP) and the real-time transport control protocol (RTCP), voice over Internet protocol (VOIP), file transfer protocol (FTP), WebSocket (WS), wireless access protocol (WAP), various messaging protocols (SMS, MMS, XMS, IMAP, SMTP, POP, WebDAV, etc.), or other known protocols.

Finally, the structure, algorithms, and/or interfaces presented herein are not inherently related to any particular computer or other apparatus. Various general-purpose systems may be used with programs in accordance with the teachings herein, or it may prove convenient to construct more specialized apparatus to perform the required method blocks. The required structure for a variety of these systems will appear from the description above. In addition, the specification is not described with reference to any particular programming language. It will be appreciated that a variety of programming languages may be used to implement the teachings of the specification as described herein.

The foregoing description has been presented for the purposes of illustration and description. It is not intended to be exhaustive or to limit the specification to the precise form disclosed. Many modifications and variations are possible in light of the above teaching. As will be understood by those familiar with the art, the specification may be embodied in other specific forms without departing from the spirit or essential characteristics thereof. Likewise, the particular naming and division of the modules, routines, features, attributes, methodologies, and other aspects are not mandatory or significant, and the mechanisms that implement the specification or its features may have different names, divisions and/or formats. Furthermore, the modules, routines, features, attributes, methodologies, and other aspects of the disclosure can be implemented as software, hardware, firmware, or any combination of the foregoing. Also, wherever a component, an example of which is a module, of the specification is implemented as software, the component can be implemented as a standalone program, as part of a larger program, as a plurality of separate programs, as a statically or dynamically linked library, as a kernel loadable module, as a device driver, and/or in every and any other way known now or in the future. Additionally, the disclosure is in no way limited to implementation in any specific programming language, or for any specific operating system or environment.

What is claimed is:

1. A computer-implemented method comprising:
receiving, by one or more processors, real-time event data for a real-time event;
determining, by the one or more processors, statistic categories from the real-time event data;
calculating, by the one or more processors, weighted statistic categories using weight functions;
clustering, by the one or more processors, the weighted statistic categories into clustered real-time statistics;
receiving, from a client device, skill allocation point selections; and
calculating, using the one or more processors, a real-time score using the clustered real-time statistics and the skill allocation point selections.

2. The computer-implemented method of claim 1, wherein the statistic category includes a first measurable statistic and a second measurable statistic.

3. The computer-implemented method of claim 2, wherein the first measurable statistic and the second measurable statistic are combined to form a first statistic category from the statistic categories.

4. The computer-implemented method of claim 1, further comprising:
updating, by the one or more processors, one or more of the weighted statistic categories in response to detecting a change in a balance of the weighted statistic categories.

5. The computer-implemented method of claim 1, wherein the skill allocation point selections are associated with the determined statistical categories and the skill allocation point selections include a first selection from a first category of the determined statistical categories and a second selection from a second category of the determined statistical categories.

6. The computer-implemented method of claim 5, wherein calculating the real-time score using the clustered real-time statistics and the skill allocation point selections, further comprises calculating the real-time score using the clustered real-time statistics, the first selection from the first category, and the second selection from the second category.

7. The computer-implemented method of claim 6, further comprising:
receiving, from the client device, an updated skill allocation point selection that changes the selection of the second selection from the second category to a third selection from a third category of the determined statistical categories.

8. The computer-implemented method of claim 7, wherein calculating the real-time score using the clustered real-time statistics and the skill allocation point selections, further comprises calculating the real-time score using the clustered real-time statistics, the first selection from the first category, and the third selection from the third category.

9. The computer-implemented method of claim 1, wherein when the skill allocation point selections are received, a timestamp of when the client device received the skill allocation point selections is also received and wherein, the timestamp is used to calculate the real-time score using the clustered real-time statistics and the skill allocation point selections in substantially real-time.

10. A system comprising:
one or more processors; and
one or more memory storing instructions that, when executed by the one or more processors, cause the system to perform operations including:
receiving real-time event data for a real-time event;
determining statistic categories from the real-time event data;
calculating weighted statistic categories using weight functions;
clustering the weighted statistic categories into clustered real-time statistics;
receiving skill allocation point selections; and
calculating a real-time score using the clustered real-time statistics and the skill allocation point selections.

11. The system of claim 10, wherein the statistic category includes a first measurable statistic and a second measurable statistic.

12. The system of claim 11, wherein the first measurable statistic and the second measurable statistic are combined to form a first statistic category from the statistic categories.

13. The system of claim 10, wherein the one or more memory further stores instructions that, when executed by the one or more processors, cause the system to perform operations including:
updating one or more of the weighted statistic categories in response to detecting a change in a balance of the weighted statistic categories.

14. The system of claim 10, wherein the skill allocation point selections are associated with the determined statistical categories and the skill allocation point selections include a first selection from a first category of the determined statistical categories and a second selection from a second category of the determined statistical categories.

15. The system of claim 14, wherein calculating the real-time score using the clustered real-time statistics and the skill allocation point selections, further comprises calculating the real-time score using the clustered real-time statistics, the first selection from the first category, and the second selection from the second category.

16. The system of claim 15, wherein the one or more memory further stores instructions that, when executed by the one or more processors, cause the system to perform operations including:
receiving an updated skill allocation point selection that changes the selection of the second selection from the second category to a third selection from a third category of the determined statistical categories.

17. The system of claim 16, wherein calculating the real-time score using the clustered real-time statistics and the skill allocation point selections, further comprises calculating the real-time score using the clustered real-time statistics, the first selection from the first category, and the third selection from the third category.

18. The system of claim 10, wherein when the skill allocation point selections are received, a timestamp of when a client device received the skill allocation point selections is also received and wherein, the timestamp is used to calculate the real-time score using the clustered real-time statistics and the skill allocation point selections in substantially real-time.

19. A method comprising:
receiving, by one or more processors, event data for a video feed of a live sporting event in substantially real-time, the event data including a first measurable statistic and a second measurable statistic captured during the live sporting event;
determining, by the one or more processors, a first statistical category that is associated with the first measurable statistics and a second statistical category that is associated with the second measurable statistic;
calculating, by the one or more processors, a first weight for the first statistical category and a second weight for the second statistical category using weight functions;
receiving, from a client device, skill allocation point selections that include a first allocation to the first statistical category and a second allocation to the second statistical category; and
calculating, using the one or more processors, a real-time score using the first weight, the first allocation to the first statistical category, and the first measurable statistic, and the second weight, the second allocation to the second statistical category, and the second weight.

20. The method of claim 19, wherein the first allocation is a multiplier quantity.
